(19) United States
(12) Patent Application Publication
(10) Pub. No.: US 2010/0165466 A1
(43) Pub. Date: Jul. 1, 2010

(54) OPTICAL SHEET FOR DISPLAY, AND MANUFACTURING METHOD AND APPARATUS THEREFOR

(75) Inventors: Keisuke Endo, Fujinomiya-shi (JP); Takehiko Nakayama, Fujinomiya-shi (JP); Naoko Saito, Fujinomiya-shi (JP)

Correspondence Address: BIRCH STEWART KOLASCH & BIRCH, PO BOX 747, FALLS CHURCH, VA, 22040-0747, US

(73) Assignee: Fujifilm Corporation, Tokyo (JP)

(21) Appl. No.: 12/095,718

(22) PCT Filed: Nov. 30, 2006
(86) PCT No.: PCT/JP2006/324394

§ 371 Date: Jul. 8, 2008

(51) Int. Cl. G02B 5/02; G02B 27/10; B32B 3/00; B32B 27/36; B32B 37/00; B32B 17/10

(52) U.S. Cl. 359/599; 359/626; 428/189; 428/480; 428/332; 156/580; 156/99

(57) ABSTRACT

An optical sheet for display use wherein two or more optical sheets are stacked therein and the optical sheets are joined to one another on one peripheral side of each by a thermoadhesive film is to be provided. Also an optical sheet for display use wherein two or more optical sheets are stacked therein and the optical sheets are joined to one another on two or more peripheral sides of each by a thermoadhesive film is to be provided. Since the optical sheets are joined to one another on one peripheral side or two or more peripheral sides of each by a thermoadhesive film, the step of cutting each of multiple films (sheets) into the product size can be omitted, and so can be the step of stacking multiple layers of films (sheets) while positioning them. Also, it is free from a problem which derives from protective sheets, resulting in advantages in both cost and quality aspects. Moreover, it is free from a problem which arises when multiple layers of films are stacked.

### TECHNICAL FIELD

The present invention relates to an optical sheet for display and a manufacturing method and an apparatus therefor, and more particularly to an optical sheet for display in a liquid crystal display element or the like and a manufacturing method and an apparatus therefor.

### BACKGROUND ART

Today, laptop personal computers, mobile phones and mobile liquid crystal TV receivers, which are equipped with a color liquid crystal display device, as well as liquid crystal display devices integrated with playback devices have suffered from large power consumption of the liquid crystal display devices that prevents the increase of the time period during which a battery can drive. Most of these liquid crystal display devices use a back light system which illuminates the liquid crystal layer from behind to light it, and such a back light system includes a back light unit provided underneath the liquid crystal layer.

Usually, a back light unit has a light source such as a cold cathode tube or an LED, an optical guide plate and a plurality of optical sheets. Available optical sheets for this use include hologram sheets, polarizing sheets, anti-reflection sheets, light reflecting sheets, transflective sheets, diffraction grating sheets, interference filter sheets, light filter sheets, optical wavelength converting sheets, optical diffusion sheets and the like. Optical sheets to be incorporated into the back light unit of a liquid crystal display device include optical diffusion sheets, lens sheets and the like.

Incidentally, it is essential to enhance the luminance of the liquid crystal display device to clearly display still images or moving images. To this end, it is conceivable to increase the amount of light of the source, to improve various optical characteristics of the optical diffusion sheets and the lens sheets, and the like.

However, any of the aforementioned products which use a liquid crystal display device are limited in consumable power to keep it usable for a long period, and there is a limitation in increasing the amount of the light emitted from the light source. Above all, power consumed by the back light used in the liquid crystal display device accounts for a high proportion to the total power consumption of the apparatus, and minimizing this power consumed by the back light is a key to extending the period during which the battery can drive the apparatus and to enhancing the practical usefulness of any of the products mentioned above.

However, it is undesirable to reduce power consumption to lead to reduction in the luminance of the back light, because the visibility of the liquid crystal display could be compromised. In view of this problem, there have been proposed optical sheet for display use to improve the optical efficiency of the back light as a method of enhancing the luminance of the liquid crystal display device without increasing power consumed by the back light (Japanese Patent Application Laid-Open No. 7-230001, Japanese Patent No. 3123006 and Japanese Patent Application Laid-Open No. 5-341132).

Japanese Patent Application Laid-Open No. 7-230001, Japanese Patent No. 3123006 and Japanese Patent Application Laid-Open No. 5-341132 propose optical diffusion sheets which diffuse lights from a light source such as an optical guide plate and lens sheets which condense lights in a frontal direction, as well as optical sheets which combine the functions of optical diffusion sheets and lens sheets. These lens sheets, however, use protective sheets to prevent streaks because only a slight streak on their front or rear surface would be noticeable and make the sheets unusable.

This means a cost disadvantage of extra steps for sticking the protective sheets and increase of material items. The additional cost is not the only problem, but there also is a disadvantage in quality that, in the process of incorporating the lens sheets and removing the protective sheets at the back light assembling step, the static charge, which occurs when the protective sheet is removed, causes micro-dust around to attach in the plane of the lens sheet and thereby causing defects.

In order to solve this problem, the present applicant has proposed to form laminated sheets comprising a plurality of optical sheets one stacked over another, for instance forming over at least either the front or rear face of each lens sheet a laminated sheet composition of stacked diffusion sheets, and to use the diffusion sheets also as protective films in preventing damages on lens sheets or adhesion of dust in the planes of lens sheets.

Examples of laminated sheet composition include a transflective polarizing film disclosed in Japanese Patent Application Laid-Open No. 2004-184575, for instance, in which a reflective polarizing film, a phase difference films and a transflective layer are stacked in any desired sequence, and an absorptive polarizing film is stacked outside these three layers. This configuration, having as many as five film layers between the light source device and the liquid crystal cell, serves to enhance the luminance of the screen or to keep power consumption lower.

Further, Japanese Patent Application Laid-Open No. 7-230001, Japanese Patent No. 3123006 and Japanese Patent Application Laid-Open No. 5-341132 disclose films in which the functions of a single optical diffusion film and a lens film are integrated.

### DISCLOSURE OF THE INVENTION

However, for any of the conventional configurations described above, stacking a number of films requires correspondingly many and complex steps of fabrication, and this inevitably increases the manufacturing cost.

Whereas flat lenses, such as lenticular lenses and prism sheets, whose surfaces are susceptible to damage and smear, are usually delivered in a state in which protective sheets are applied to their surfaces, such protective sheets are merely discarded once they are removed from the flat lenses, and this is undesirable because it not only is wasteful but also adds to the manufacturing cost. Moreover, the extra work of removing the protective sheets off the flat lenses, resulting in a corresponding drop in productivity. Moreover, the static charge, which occurs when the protective sheets are removed from the flat lenses, is likely to contaminate the flat lenses with dust or the like, which poses a problem of qualitative deterioration.

Also, when a number of films (sheets) are stacked, the films may be often damaged by friction suffered during their stacking, scraping due to thermal expansion or contraction, or rubbing in the course of handling.

Moreover, it may sometimes be necessary to increase the thicknesses (increase the rigidity) of individual films or to take some other measure to correct deformation (such as distortion or curling) due to mismatching among the plurality of films resulting from thermal expansion or contraction, inviting many disadvantages including design constraints and additional costs.

Furthermore, where a plurality of optical sheets are to be integrated by welding for instance, molten parts of the optical sheets may bulge out of the laminated sheet composition and thereby change the size of the laminated sheet composition after their joining. There is another problem that differences in thermal expansion or contraction among the plurality of optical sheets of different types may invite bending of the joined laminated sheet composition. Such a change of the laminated sheet composition from the designed size or their bending would have an adverse effect on their optical performance.

An object of the present invention, attempted in view of these circumstances, is to provide an optical sheet for display use, which is suitable for manufacturing sheet-shaped laminates of higher quality to be used for display applications, such as liquid crystal display elements, in a simpler process at a lower cost than conventional such products, and a manufacturing method and an apparatus therefor.

Another object of the invention, attempted in view of these circumstances, is to provide an optical sheet for display use, which enables, where a plurality of optical sheets are to be stacked and joined in at least one position on the periphery of each laminated sheet composition, the dimensional accuracy of the laminated sheet composition to be maintained and the sheets to be prevented from being bent, and a manufacturing method and an apparatus therefor.

In order to achieve the objects stated above, the invention provides an optical sheet for display use, wherein two or more optical sheets are stacked therein and the optical sheets are joined to one another on one peripheral side of each by a thermoadhesive film.

Also the invention provides an optical sheet for display use, wherein two or more optical sheets are stacked therein and the optical sheets are joined to one another on two or more peripheral sides of each by a thermoadhesive film.

According to the invention, since the optical sheets are joined to one another on or more peripheral side or two or more peripheral sides of each by a thermoadhesive film, the step of cutting each of multiple films (sheets) into the product size can be omitted, and so can be the step of stacking multiple layers of films (sheets) while positioning them. Also, it is free from the above-noted problem which derives from protective sheets, resulting in advantages in both cost and quality aspects. Moreover, it is free from the aforementioned problem which arises when multiple layers of films are stacked.

Further, mismatching among a plurality of films due to thermal expansion or contraction is alleviated by the thermoadhesive film layer, and accordingly deformation (such as distortion or curling) due to mismatching hardly occurs. Therefore, it is unnecessary to increase the thicknesses (increase the rigidity) of individual films or to take any other measure to correct this deformation, resulting in reduced design constraints and an advantage due to cost saving. Details and various advantages of this thermoadhesive film will be described in detail afterwards.

By virtue of these advantages, sheet-shaped laminates of higher quality to be used for display applications, such as liquid crystal display elements, can be manufactured in a simpler process at a lower cost according to the invention than conventional such products.

Incidentally, the optical sheets (optical films) is the generic name of all kinds of sheets having optical functions, typically including diffusion sheets, polarizing plates (polarizing sheet films), various lens sheets (lenticular lenses, fly eye lenses, prism sheets and so forth), anti-reflection sheets, light reflecting sheets, transflective sheets, diffraction grating sheets, interference filter sheets, color filter sheets, optical wavelength converting sheets and hologram sheets, but protective sheets (protective films) which hardly perform any optical function are also covered by this term.

According to the invention, it is preferable for the thermoadhesive film to be positioned between the optical sheets on the peripheral side or sides. Such a configuration in which the thermoadhesive film is positioned between the optical sheets is easier to assemble and the clearance between the optical sheets can be more easily uniformized.

It is also preferable according to the invention for the thermoadhesive film to be arranged in a position of no more than 2 to 4 mm from the edges of the optical sheets. Arrangement of the thermoadhesive film in such a position makes the viewing range of the display device practically immune from adverse effects and enables a sufficient adhesive force to be secured.

It is also preferable according to the invention for the thermoadhesive film to be adhered to the end faces of the optical sheets on the peripheral side or sides. Such a configuration in which the thermoadhesive film is adhered to the end faces of the optical sheets can also facilitate assembling and, even if it becomes necessary to remove the thermoadhesive film, the removing can be easily accomplished.

It is also preferable according to the invention for the thickness of the thermoadhesive film after the adhesion to be not more than 0.1 mm. Such a thickness would enable the clearance between the optical sheets to be more easily uniformized, and any trouble that could give rise to interference fringes hardly occurs.

It is also preferable according to the invention for the thermoadhesive film to be a polyester film. The material of thermoadhesive film may as well be a polyamide, polyurethane or ethylene vinyl acetate (EVA), but a polyester film can achieve both high adhesiveness and high flexibility at the same time.

It is also preferable according to the invention for the optical sheets to include diffusion sheets. It is also preferable for optical sheets to include a lens sheet over which convex lenses formed in a monoaxial direction are arranged substantially all over the face adjoining one another. Incidentally, the “lens sheet over which convex lenses formed in a monoaxial direction are arranged substantially all over adjoining one another” typically is a lenticular lens or a prism sheet, and may be a diffraction grating.

It is also preferable according to the invention for the optical sheets to include two or more sheets of the same optical performance. A case in which two or more sheets of the same optical performance are included may be, for instance, one in which two lens sheets convex lenses formed in a monoaxial direction are arranged substantially all over adjoining one another are stacked in a direction in which the axes of the convex lenses are orthogonal, or another in which diffusion sheets are stacked over the front and rear faces of this laminate of lens sheets. Incidentally, though a state in which lenses are “stacked in a direction in which the axes of the convex lenses are orthogonal”, the angle may be adjusted to some extent to prevent moiré fringes or the like.

In order to achieve the objects stated above, the invention provides an optical sheet for display use, wherein two or more optical sheets are stacked and a through hole or holes are formed in one or more positions of the edge of the stacked laminate and the optical sheets are engaged with each other by the through hole or holes.

To achieve these objects, the present invention provides an apparatus for manufacturing an optical sheet for display use provided with a table which holds two or more stacked optical sheets; an elevating stage which brings up and down a plurality of acicular members; and a heating device which heats the acicular members, wherein the heated acicular members can form through holes in a plurality of positions on the edge of the laminate of the optical sheets.

According to the invention, since through holes are formed in more than one positions on the edge of the laminate of the optical sheets and the optical sheets are engaged with each other by the through holes, the step of cutting a plurality of films (sheets) to the product size can be omitted, and so can be the step of stacking multiple layers of films (sheets) while positioning them. Also, it is free from the above-noted problem which derives from protective sheets, resulting in advantages in both cost and quality aspects. Moreover, it is free from the aforementioned problem which arises when multiple layers of films are stacked.

Further, mismatching among the plurality of films due to thermal expansion or contraction is alleviated by the engagement of the through hole or holes formed at intervals, and accordingly deformation (such as distortion or curling) due to mismatching can hardly occur. Therefore, it is unnecessary to increase the thicknesses (increase the rigidity) of individual films or to take any other measure to correct this deformation, resulting in reduced design constraints and an advantage due to cost saving.

By virtue of these advantages, sheet-shaped laminates of higher quality to be used for display applications, such as liquid crystal display elements, can be manufactured in a simpler process at a lower cost according to the invention than conventional such products.

Incidentally, the optical sheets (optical films) according to the invention are the same as those enumerated above.

It is also preferable according to the invention for the through hole or holes to be formed by melting the optical sheets. If the through hole or holes are formed by melting the optical sheets, the molten parts of the sheets can be more easily engaged with each other, resulting in a better state of engagement between the optical sheets. The use of an acicular member, to be described afterwards, for melting the optical sheets is preferable, but other known methods, such as laser treatment and ultrasonic heating, can as well be used.

It is also preferable according to the invention for the through hole or holes to be arranged in a position of no more than 3 mm from the edges of the optical sheets. Arrangement of the through hole or holes in such a position makes the viewing range of the display device practically immune from adverse effects and enables a sufficiently firm engagement to be secured. Incidentally, the position of any through hole no more than 3 mm away from the edge means that the edge of the through hole inside a sheet is not more than 3 mm away from the edge of the sheet.

It is also preferable according to the invention for the diameter of the through hole or holes to be 0.3 to 2.0 mm. If the diameter of the through hole is within this range, sufficiently firm engagement can be secured, and the sheets can be relatively well prevented from the trouble of large distortion (thermal deformation) and interference fringes.

It is also preferable according to the invention for the through hole or holes to be formed with a heated acicular member. The use of such a heated acicular member would facilitate mass production on an industrial scale. Moreover, no expendables would be needed, which is an advantage in manufacturing cost. Furthermore, the resultant absence of bulging out due to the melting of sheets would provide an advantage in the quality aspect.

It is also preferable according to the invention for the density of the through holes in the mutual engaging parts of the optical sheets to be not less than two per cm². If the density of through holes is in this range, sufficiently firm engagement can be secured. Incidentally, the density of through holes in this context means the quotient of division of the number of through holes, in a state in which a plurality of through holes are formed adjoining one another, by the area surrounding this plurality of through holes. It is more preferable for this density of through holes to not less than four per cm², or still more preferable to be not less than six per cm².

It is also preferable according to the invention for the mutual engaging parts of the optical sheets to be squeezed by holding members from above and underneath when the through hole or holes are formed with the heated acicular member. This squeezing of the mutual engaging parts by the holding members would make it difficult for the molten parts of the sheets to enter between the optical sheets and thereby to give rise to distortion or interference fringes of the sheets.

It is also preferable according to the invention that an insertion hole or holes or an insertion groove or grooves allowing the acicular member are inserted are formed in one or both of the holding members. Such an insertion hole or holes or an insertion groove or grooves allowing the acicular member to be inserted would enable the edge of the acicular member to be squeezed, and would make it even more difficult for the molten parts of the sheets to enter between the optical sheets and thereby to give rise to distortion or interference fringes of the sheets.

It is also preferable according to the invention for the mutually engaging parts of the optical sheets to be squeezed between an upper holding member in which an insertion hole allowing the acicular member to be inserted is formed and a lower holding member in which an insertion groove allowing the acicular member to be inserted is formed when the through hole or holes are formed with the heated acicular member. Since the edge of the acicular member can also be squeezed in such a mode, it can be made even more difficult for the molten parts of the sheets to enter between the optical sheets and thereby to give rise to distortion or interference fringes of the sheets.

It is also preferable according to the invention for the bore of the insertion hole and/or the width of the insertion groove to be 1.02 to 4 times the diameter of the acicular member. As such a bore and/or a groove width would enable the edge of the acicular member to be squeezed without a gap, it can be made even more difficult for the molten parts of the sheets to enter between the optical sheets and thereby to give rise to distortion or interference fringes of the sheets. Incidentally, it is more preferable for the bore and/or the groove width to be 1.5 to 3 times the diameter of the acicular member, or still more preferable to be 1.8 to 2.5 times the diameter of the acicular member.

It is also preferable according to the invention for the optical sheets to include a diffusion sheet. Also, it is preferable according to the invention for the optical sheets to include a lens sheet over which convex lenses formed in a monoaxial direction are arranged substantially all over adjoining one another. Incidentally, the “lens sheet over which convex lenses formed in a monoaxial direction are arranged substantially all over adjoining one another” typically is a lenticular lens or a prism sheet, and may as well be a diffraction grating or the like.

It is also preferable according to the invention for the optical sheets to include two or more sheets of the same optical performance. An example in which two or more sheets of the same optical performance are included was already described.

In order to achieve the objects stated above, the present invention provides a method of manufacturing an optical sheet for display use including a joining step at which a laminated sheet composition formed by stacking three or more optical sheets is joined in at least one position of the edge thereof to integrate the composition, wherein only the optical sheet constituting the top layer and the optical sheet constituting the bottom layer of the laminated sheet composition are joined at the joining step.

According to the invention, at the joining step at which a laminated sheet composition formed by stacking three or more optical sheets is joined in at least one position of the edge thereof to integrate the composition, only the optical sheet constituting the top layer and the optical sheet constituting the bottom layer of the laminated sheet composition are joined. This causes the optical sheet for display use, which is a laminated sheet composition, to be integrated in a form of holding an optical sheet which constitutes the intermediate layer between the optical sheets of the top layer and the bottom layer. Therefore, the optical sheet of the intermediate layer is only held between but not joined to the optical sheets of the top layer and the bottom layer, with the result that the laminated sheet composition is hardly susceptible to deformation (such as distortion or curling) even if the thermal expansion or contraction occurs among the plurality of optical sheets.

By joining only the optical sheets of the top layer and the bottom layer, even if they are melt-joined, the generation of molten matter can be kept less than when the whole laminated sheet composition including the intermediate layer is melt-joined. As this makes it more difficult for molten matter to bulge out of the laminated sheet composition, the problem of a change in size of the laminated sheet composition after joining is eliminated.

Incidentally, the number of optical sheet constituting the intermediate layer is not limited to one, but may be more than one. Further, the number of positions on the edge of the optical sheets of the top layer and the bottom layer in which they are to be joined can be appropriately selected within a range in which the intermediate layer may not come off during the handling of the laminated sheet composition or on any other occasion, but it is preferable to be as small as possible with a view to reducing the bending of the composition.

According to the invention, it is preferable for only the optical sheets of the top layer and of the bottom layer to be joined by forming the intermediate layer of optical sheets between the top layer and the bottom layer in a smaller planar size than the optical sheets of the top layer and the bottom layer. This is a preferable mode for joining only the optical sheets of the top layer and the bottom layer, wherein the intermediate layer of optical sheets between the top layer and the bottom layer is formed in a smaller planar size than the optical sheets of the top layer and the bottom layer. By forming the intermediate layer of optical sheets in a smaller planar size than the optical sheets of the top layer and the bottom layer in this way, an annular gap is formed in the dimensional difference part between the top layer and the bottom layer on one hand and the intermediate layer on the other, and molten matter generated in the joining process is accommodated in this gap, making it even more difficult for the molten matter to bulge out of the laminated sheet composition. Incidentally, though the commonest planar shape of the top layer, the bottom layer and the intermediate layer is rectangular, there is no particular limitation regarding their shape, and they only need to be similar in shape.

Further according to the invention, it is preferable for the intermediate layer of optical sheets to be internally contained by joining the whole edges of the optical sheets of the top layer and the bottom layer. This is to join the whole edges of the optical sheets of the top layer and the bottom layer to form them into a bag shape and contain the intermediate layer in this bag. This serves to prevent the intermediate layer of optical sheets from falling when the laminated sheet composition is handled.

Also according to the invention, it is preferable for a notch to be cut in at least one position of the edge of the intermediate layer of optical sheets between the top layer and the bottom layer and the optical sheets of only the top layer and of the bottom layer to be joined via this notch. This is another preferable mode for joining the optical sheets of the top layer and the bottom layer, in which a notch is cut in at least one position of the edge of the intermediate layer of optical sheets and the optical sheets of only the top layer and of the bottom layer are joined via this notch. By cutting a notch in at least one position of the edge of optical sheets in this way, the molten matter generated in the joining process is accommodated in this notch, and it is made even more difficult for the molten matter to bulge out of the laminated sheet composition.

Further according to the invention, it is preferable for a hole to be formed in at least one position of the edge of the intermediate layer of optical sheets between the top layer and the bottom layer and the optical sheets of only the top layer and of the bottom layer to be joined via this hole. This is another preferable mode for joining only the optical sheets of the top layer and the bottom layer, in which a hole is be formed in at least one position of the edge of the intermediate layer of optical sheets between the top layer and the bottom layer, and the optical sheets of only the top layer and of the bottom layer are joined via this hole. By boring a hole in at least one position of the edge of the intermediate layer of optical sheets in this way, the molten matter generated in joining process is accommodated in this hole, and it is made even more difficult for the molten matter to bulge out of the laminated sheet composition. Incidentally, it is preferable that the position of holes to be formed in the intermediate layer is at four corners (angles) of the rectangular optical sheets.

Also according to the invention, it is preferable for the top layer and the bottom layer, out of the three or more optical sheets, to be optical sheets of the same type. By using optical sheets of the same type for the top layer and the bottom layer in this way, thermal expansion or contraction is equalized, making it even more difficult for the laminated sheet composition to bend.

Further according to the invention, it is preferable for the three or more optical sheets to comprise a lens sheet and diffusion sheets and the diffusion sheets to be arranged in the top layer and the bottom layer. This means that the lens sheet can be protected by configuring the laminated sheet composition of a lens sheet and diffusion sheets as the type of optical sheet constituting a laminated sheet and arranging the diffusion sheets in the top layer and the bottom layer. Incidentally, the intermediate layer is not limited to a lens sheet but may be a combination of a lens sheet and a diffusion sheet.

Also according to the invention, it is preferable for the optical sheet of the intermediate layer is joined to part of the optical sheet of the top layer and/or bottom layer. This is because, if the intermediate sheet may come off or become displaced during the handling of the laminated sheet composition where the optical sheet of the intermediate layer is merely held between the optical sheets of the top layer and the bottom layer, it is preferable to join the optical sheet of the intermediate layer to part of the optical sheets of the top layer and/or bottom layer.

In order to achieve the objects stated above, the present invention provides an optical sheet for display use integrated by being joined in at least one position of the edge of a laminated sheet composition formed by stacking three or more optical sheets, wherein only the optical sheet of the top layer and the optical sheet of the bottom layer of the laminated sheet composition are joined.

An optical sheet for display use like this optical sheet for display use according to the invention, in which only the optical sheet of the top layer and the optical sheet of the bottom layer of the laminated sheet composition are joined but the intermediate layer is not joined hardly allows any deformation (such as distortion or curling) to occur even if there is any difference in thermal expansion or contraction among the plurality of optical sheets. Moreover, as it is made even more difficult for the molten matter to bulge out of the laminated sheet composition, the dimensional accuracy of the laminated sheet composition can be well maintained.

In this optical sheet for display use according to the invention, it is preferable for the intermediate layer of optical sheets between the top layer and the bottom layer to be formed in a smaller planar size than the optical sheets of the top layer and the bottom layer and for the intermediate layer of optical sheets to be internally contained by joining the whole edges of the optical sheets of the top layer and the bottom layer. The purpose is to securely prevent the intermediate layer of optical sheets from coming off during the handling of the laminated sheet composition.

According to the invention, it is preferable for a notch to be cut in at least one position of the edge of the intermediate layer of optical sheets between the top layer and the bottom layer, and the optical sheets of only the top layer and of the bottom layer to be joined via this notch.

Also according to the invention, it is preferable for a hole to be formed in at least one position of the edge of the intermediate layer of optical sheets between the top layer and the bottom layer and the optical sheets of only the top layer and of the bottom layer to be joined via this hole.

These are other modes in which it is made difficult for any deformation (such as distortion or curling) to occur in the laminated sheet composition and even more difficult for the molten matter to bulge out of the laminated sheet composition.

Further according to the invention, it is preferable for the three or more optical sheets to comprise a lens sheet and diffusion sheets and the diffusion sheets to be arranged in the top layer and the bottom layer. This means that the types of optical sheets constituting the laminated sheet composition are lens sheets and diffusion sheets, and arranging the diffusion sheets in the top layer and the bottom layer makes it possible to protect the lens sheets.

In order to achieve the objects stated above, the present invention provides a method of manufacturing an optical sheet for display use including a joining step at which a laminated sheet composition formed by stacking a plurality of optical sheets is joined in one or more positions of the edge thereof to integrate the composition, wherein the laminated sheet composition is joined at the joining step by punching the peripheral part of the laminated sheet composition in a desired punched shape leaving a linking part.

According to the invention, at the joining step at which the laminated sheet composition formed by stacking a plurality of optical sheets is joined in one or more positions of the edge thereof to integrate the composition, the laminated sheet composition is joined by punching the peripheral part of the laminated sheet composition in a desired punched shape leaving a linking part. Thus, a microscopic view of the punched section of the laminated sheet composition resulting from the punching leaving the linking part reveals that optical sheets on both sides of the punching line constitute a fault structure. This fault structure causes optical sheets on both sides of the punching line to engage with each spanning different layers. This enables the laminated sheet composition to be coupled with a joining force which no such external force as that of handling can surpass. Therefore, the laminated sheet composition can be integrated by joining without having to use a welding method or an expendable such as an adhesive. This neither allows molten matter to deteriorate the dimensional accuracy of the laminated sheet composition as is the case with welding nor subjects the joined laminated sheet composition to bending caused by differences in thermal expansion or contraction due to differences in type among the plurality of optical sheets because of its weaken joining force than that of welding or an adhesive. In this case, punching is not limited to an action from only one side of the laminated sheet composition but may be accomplished by a combination of a punched shape resulting from punching in one direction and another shape resulting from punching in another direction.

Incidentally, joining the peripheral part of the laminated sheet composition is intended to prevent the optical sheet for display use, when it is fitted to a liquid crystal display element, from covering any part of the screen of the liquid crystal element.

According to the invention, it is preferable for the punching to be shaped in a C shape or a U shape. This refers to preferable shapes of the punched shape which is recommended to be C or U. However, the punched shape is not limited to these, but may be a partly open rectangular or triangular shape so that the linking part can be formed. The linking part is not necessarily limited to one, but may be more than one.

Also according to the invention, it is preferable for a pair of the punched shapes to be formed opposite each other. By forming a pair of the punched shapes opposite each other in this way, the optical sheets can be restricted from deviating from each other with no clearance between them.

Further according to the invention, it is preferable for the laminated sheet composition to be punched leaving a linking part and that linking part to be pressed at the joining step. By punching the laminated sheet composition leaving a linking part and pressing this linking part in this way, the linking part is given a folding pattern and the integration of the laminated sheet composition with a joining force which can well resist such an external force as that of handling is made even more secure.

Also according to the invention, it is preferable for the proportion of the length of the linking part to the whole outer circumferential length of the punched shape to be no more than 50%. This is because, if this proportion exceeds 50%, the linking part will become too large relative to the outer circumference of the punch to readily permit folding by pressing.

Further according to the invention, it is preferable for the punching to be accomplished together with the punching of an uncut laminated sheet composition, the planar size of whose sheet is greater than the product size, into a laminated sheet composition of the product size. This simultaneous punching of the uncut laminated sheet composition into the product size and the punching for joining enables the joining step as such to be omitted and correspondingly contributes to shortening the processing time.

Also according to the invention, it is preferable for the punching to be so accomplished as to form the punched shape in two or more positions on the peripheral part of the laminated sheet composition. If the punched shape is formed on only one side of the peripheral part of the laminated sheet composition, no sufficient restrictive force against the turning of the optical sheets relative to each other can be obtained. Therefore, it is preferable to form the punched shape on two or more sides, more preferable on two adjoining sides (arranged at an angle of 90 degrees to each other) to achieve a sufficient restrictive force against the turning of the optical sheets relative to each other.

Further according to the invention, it is preferable for a step of folding back the part of the punched shape toward the rear face of the laminated sheet composition with the linking part as the base end to be included. This is intended to make even more secure the integration of the laminated sheet composition with a joining force, which can well resist such an external force as that of handling, by folding back the part of the punched shape toward the rear face of the laminated sheet composition with the linking part as the base end.

In order to achieve the objects stated above, the present invention provides an apparatus for manufacturing an optical sheet for display use provided with a joining device which integrates a laminated sheet composition, formed by stacking a plurality of optical sheets, by joining the composition in one or more positions on the peripheral part thereof, wherein the joining device is a punching press device provided with a punching blade for joining use, in which a notch for punching the composition leaving a linking part intact is cut.

This is an apparatus embodying the invention, wherein the joining device is a punching press provided with a punching blade for joining use, in which a notch for punching the composition leaving a linking part intact is cut. By punching the laminated sheet composition with this punching press provided with the punching blade for joining use, the laminated sheet composition can be joined. Incidentally, it is preferable for the edge angle of the punching blade for joining use to be not less than 43°.

Also in the apparatus according to the invention, it is preferable for the outer circumferential part of the punching blade for joining use to be provided with a pressing device for pressing the vicinities of the punching position in the laminated sheet composition when pulling out the punching blade for joining use after punching the laminated sheet composition. The optical sheets on both sides of the punching line constitute a fault structure, and this fault structure causes optical sheets on both sides of the punching line to engage with each spanning different layers. Therefore, when the punching blade for joining use is pulled out of the laminated sheet composition, the fault structure may return to the pre-punching state, and the joining force may be lost or weakened. In view of this problem, the pressing device for pressing the vicinities of the punching position in the laminated sheet composition when pulling out the punching blade for joining use is provided to prevent the fault structure from returning to the pre-punching state and thereby to secure a sufficient joining force.

Also in the apparatus according to the invention, it is preferable for the punching blade for joining use to be C-shaped or U-shaped, and a pressing bar to be arranged within the C-shape or U-shape of the punching blade for joining use. As stated above, the joining mechanism according to the invention restricts positional deviation of the optical sheets relative to each other by pressing and folding back the punched part.

Further in the apparatus according to the invention, it is preferable for the tip of the pressing bar to be flush with the tip of the punching blade for joining use. Even if the tip of the pressing bar is slightly behind or ahead the tip of the punching blade for joining use, the effect of pressing and folding back the punched part can be achieved, aligning them on the same plane enables this effect to be achieved more securely.

Also in the apparatus according to the invention, it is preferable for the punching blade for joining use is arranged over two or more sides of the peripheral part of the laminated sheet composition. This is intended to provide a restrictive force against the turning of the optical sheets relative to each other as mentioned above.

Also in the apparatus according to the invention, it is preferable for the punching blade for joining use to be disposed in a punching press for punching an uncut laminated sheet composition, the planar size of whose optical sheet is greater than the product size, into a laminated sheet composition of the product size. In this configuration, since the punching blade for joining use is disposed in a punching press for punching an uncut laminated sheet composition, the planar size of whose optical sheet is greater than the product size, into a laminated sheet composition of the product size, the resultant simultaneous punching of the uncut laminated sheet composition into the product size and the punching for joining enables the joining step as such to be omitted and correspondingly contributes to shortening the processing time.

In order to achieve the objects stated above, the present invention provides an optical sheet for display use integrated by joining the composition in one or more positions on the peripheral part of the laminated sheet composition formed by stacking a plurality of optical sheets, wherein the laminated sheet composition is joined by the engagement of the optical sheets with each other, as the peripheral part of the laminated sheet composition is punched in a desired punched shape leaving a linking part, in that punched section.

The optical sheet for display use according to the invention allows the dimensional accuracy of the laminated sheet composition to be maintained and is free from being bent. Furthermore, as it requires neither a welding method nor an adhesive, it contributes to cost reduction.

As described so far, the invention enables an optical sheet for display use of higher quality to be manufactured in a simpler process at a lower cost.

Further according to the invention, where three or more optical sheets are stacked and joined at least in one or more positions on the edge of the laminated sheet composition, the dimensional accuracy of the laminated sheet composition can be maintained, and the resultant optical sheet for display use is free from being bent.

Moreover, according to the invention, where a plurality of optical sheets are stacked and joined in at least one or more positions on the edge of the laminated sheet composition, the dimensional accuracy of the laminated sheet composition can be maintained and the composition can be prevented from being bent without having to use an expendable such as an adhesive, resulting in a contribution to shortening the processing time.

### BRIEF DESCRIPTION OF THE DRAWINGS

FIG. 1 shows a sectional view of an optical sheet for display use manufactured by a method of manufacturing an optical sheet for display use in the first embodiment of the present invention;

FIG. 2 shows a sectional view of an optical sheet for display use in another embodiment of the invention;

FIG. 3 shows a sectional view of an optical sheet for display use in still another embodiment of the invention;

FIG. 4 shows a sectional view of an optical sheet for display use in still another embodiment of the invention;

FIG. 5 shows a sectional view of an optical sheet for display use in still another embodiment of the invention;

FIG. 6 shows a sectional view of an optical sheet for display use in still another embodiment of the invention;

FIGS. 7A and 7B illustrate a joint of an optical sheet for display use;

FIGS. 8A and 8B illustrate a joint of an optical sheet for display use;

FIG. 9 shows the configuration of a manufacturing line for an optical sheet for display use;

FIGS. 10A and 10B illustrate the planar arrangement of sheets punched out of a laminate;

FIG. 11 is a plan illustrating a joint of an optical sheet for display use;

FIG. 12 shows the overall configuration of a manual through hole boring device in the second embodiment of the invention;

FIG. 13 shows a right side profile of the through hole boring device;

FIG. 14 shows a partial enlarged view of FIG. 13;

FIG. 15 shows details of an acicular member;

FIG. 16 shows a perspective view of the positional relationship between the acicular member and a holding plate, which is an upper holding member;

FIG. 17 shows a state in which an acicular member penetrates an optical sheet for display use;

FIG. 18 shows a sectional view of a table;

FIG. 19 shows the configuration of a manufacturing line for an optical sheet for display use;

FIG. 20 is a plan of an optical sheet for display use showing a preferable mode of the position for formation of through holes;

FIG. 21 is a plan of an optical sheet for display use showing another preferable mode of the position for formation of through holes;

FIGS. 22A, 22B and 22C are plans of an optical sheet for display use showing still another preferable mode of the position for formation of through holes;

FIG. 23 is a plan of an optical sheet for display use showing still another preferable mode of the position for formation of through holes;

FIG. 24 shows another state in which an acicular member penetrates an optical sheet for display use;

FIG. 25 shows the configuration of a manufacturing line for an optical sheet for display use in the third embodiment of the invention;

FIGS. 26A and 26B illustrate the first embodiment of the manufacturing method according to the invention;

FIGS. 27A and 27B illustrate the second embodiment of the manufacturing method according to the invention;

FIG. 28 illustrates the third embodiment of the manufacturing method according to the invention;

FIG. 29 illustrates the fourth embodiment of the manufacturing method according to the invention;

FIG. 30 illustrates the fifth embodiment of the manufacturing method according to the invention;

FIG. 31 illustrates the sixth embodiment of the manufacturing method according to the invention;

FIG. 32 illustrates a laser irradiating device, which is one example of joining device;

FIG. 33 illustrates an ultrasonic welding device, which is one example of joining device;

FIG. 34 is a conceptual diagram showing the overall configuration of a manufacturing line for an optical sheet for display use in the fourth embodiment of the invention;

FIG. 35 shows a perspective view of the entire configuration of manufacturing line for an optical sheet for display use according to the invention;

FIG. 36 illustrates a punching blade for joining use;

FIG. 37 is an arrowed diagram along line A-A in FIG. 36;

FIG. 38 is another arrowed diagram along line A-A in FIG. 36;

FIG. 39 is an arrowed diagram along line B-B in FIG. 36;

FIG. 40 illustrates the mechanism of joining by the punching action of a punching blade for joining use;

FIG. 41 illustrates a punching blade for joining use in another mode;

FIG. 42 illustrates the punching blade for joining use with focus on its edge angle;

FIGS. 43A and 43B illustrate punching of an uncut laminated sheet composition by the punching blade for joining use;

FIGS. 44A, 44B, and 44C illustrate the shape and arrangement of the punching blade for joining use;

FIG. 45 illustrates how a plurality of punched shapes are formed on one side of the peripheral part of a laminated sheet composition by the punching blade for joining use;

FIG. 46 illustrates how punched shapes are formed in the four corners of the laminated sheet composition by the punching blade for joining use;

FIG. 47 illustrates how the laminated sheet composition is punched from both the front and rear surfaces by the punching blade for joining use;

FIG. 48 is a table showing the compositions of resin liquids used for the preparation of a prism sheet;

FIG. 49 shows the configuration of a manufacturing apparatus for prism sheets;

FIG. 50 is a table showing the results of evaluation of performance in the first embodiment of the invention; and

FIG. 51 is a table showing the results of evaluation of performance in the second embodiment of the invention.

### DESCRIPTION OF SYMBOLS

10, 20, 30, 40, 50, 60 . . . Optical sheet for display use
10A, 20A, 30A, 40A, 50A, 60A . . . . Joining units
12 . . . First diffusion sheet
14 . . . First prism sheet
16 . . . Second prism sheet
18 . . . Second diffusion sheet
72 . . . Impulse sealer
152 . . . Manual through hole boring device
154 . . . Table
156 . . . Elevating stage
158 . . . Heater block
162 . . . Arm stand
164 . . . Arm
166 . . . Holding plate
178 . . . Automatic through hole boring device
180 . . . Through hole
217, 219, 221 . . . Punching press
234 . . . Gap
236 . . . Molten matter
238 . . . Notch
240 . . . Gap
244 . . . Hole
246 . . . Through hole
419 . . . Pressing bar
420 . . . Punching blade for joining use
421 . . . Notch
427 . . . Linking part
448 . . . Punching press

### BEST MODE FOR CARRYING OUT THE INVENTION

Preferable modes for carrying out the present invention to provide an optical sheet for display use and a manufacturing method and an apparatus therefore will be described below with reference to the accompanying drawings.

### First Embodiment for Carrying Out the Invention

Regarding the first embodiment for carrying out the invention, to begin with, configuration of examples of optical sheets for display use of the laminated sheet composition type according to the invention (first through sixth examples) will be described.

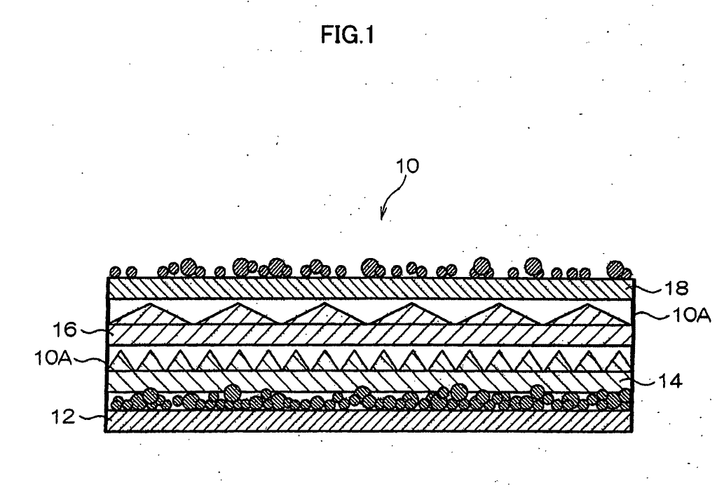

FIG. 1 is a sectional view showing the configuration of an example (first example) of an optical sheet for display use. This optical sheet for display use 10 is a module of optical sheets configured by stacking, in an ascending order, a first diffusion sheet 12, a first prism sheet 14, a second prism sheet 16 and a second diffusion sheet 18.

The first diffusion sheet 12 and the second diffusion sheet 18 are sheets each having beads fixed with a binder on the surface (one face) of a transparent film (support), and have prescribed light diffusion characteristics. The first diffusion sheet 12 and the second diffusion sheet 18 differ from each other in bead diameter (average grain size) as well as in light diffusion characteristics.

Resin films can be used as the transparent films (supports) for the first diffusion sheet 12 and the second diffusion sheet 18. Materials usable for the resin films include such known ones as polyethylene, polypropylene, polyvinyl chloride, polyvinylidene chloride, polyvinyl acetate, polyester, polyolefin, acryl, polystyrene, polycarbonate, polyamide, PET (polyethylene terephthalate), polyethylene terephthalate having undergone biaxial elongation, polyethylene naphthalate, polyamide imide, polyimide, aromatic polyamide, cellulose acylate, cellulose triacetate, cellulose acetate propionate, cellulose diacetate. Particularly preferable ones among these include polyester, cellulose acylate, acryl, polycarbonate and polyolefin.

The diameter of the beads for the first diffusion sheet 12 and the second diffusion sheet 18 should be no more than 100 μm, and preferably no more than 25 μm. For instance, the average grain size can be 17 μm in a prescribed distribution range of 7 to 38 μm.

The first prism sheet 14 and the second prism sheet 16 are lens sheets substantially all over the surface where convex lenses formed in a monoaxial direction are arrayed adjoining together, and its pitch, convex-concave height and peak angle of the convex portion can be, for instance, 50 μm, 25 μm and 90 degrees (right angle), respectively.

The first prism sheet 14 and second prism sheet 16 are arranged with their axes of convex lenses (prism) in orthogonal direction. Thus, referring to FIG. 1, the axes of the convex lenses of the first prism sheet 14 are arranged in a direction perpendicular to the drawing surface, and the axes of the convex lenses of the second prism sheet 16, in a direction parallel to the drawing surface. Incidentally the illustration in FIG. 1 is in a different direction from the reality to facilitate understanding of the fact the section of the second prism sheet 16 comprises convex lenses.

The material and manufacturing method of the first prism sheet 14 and the second prism sheet 16 can be selected from various known options. For instance, one of the available resin sheet manufacturing methods is to squeeze a sheet-shaped resin material pushed out of a die between a transfer roller (on whose surface an inverted pattern of the prism sheet is formed) turning at a substantially equal speed to the speed at which this resin material is pushed out and a nip roller plate arranged opposite this transfer roller and turning at the same speed and thereby transfer the convex-concave pattern of the surface of the transfer roller to the resin material.

Another available resin sheet manufacturing method is to stack a transfer mold plate (stamper) on whose surface an inverted pattern of the prism sheet is formed by hot pressing and a resin plate one over the other and to perform press molding by thermal transfer.

Thermoplastic resins used in these manufacturing processes include, for instance, polymethyl methacrylate resin (PMMA), polycarbonate resin, polystyrene resin, MS resin, AS resin, polypropylene resin, polyethylene resin, polyethylene terephthalate resin, polyvinyl chloride resin (PVC), thermoplastic elastomer, their copolymers and cycloolefin polymer.

As another applicable manufacturing method of a resin sheet, a method can be used such that the convex-concave pattern of the surface of a convex-concave roller (on whose surface an inverted pattern of the prism sheet is formed) is transferred to and formed on the surface of a transparent resin film similar to that used for the first diffusion sheet 12 and the second diffusion sheet 18 (polyester, cellulose acylate, acryl, polycarbonate, polyolefin or the like).

More specifically, a convex-concave sheet manufacturing method can be used by which the transparent film formed in two or more layers of adhesive and of resin (e.g. UV-setting resin) by successively applying an adhesive and a resin onto the surface is continuously run and wound round a turning convex-concave roller to transfer the convex-concave pattern on the surface of the convex-concave roller to the resin layer, and the resin layer is hardened (by irradiation with UV rays for instance) in the state in which the transparent film is wound round the convex-concave roller. Incidentally, the adhesive may be omitted.

It has to be noted that the methods of manufacturing the first prism sheet 14 and the second prism sheet 16 are not limited to the examples cited above, but any other method can be applied only if it enables a desired convex-concave pattern to be formed on the surface.

As shown in FIG. 1, at the right and left ends of the optical sheet for display use 10, the constituent layers are integrated by joints 10A. Details of the joints 10A will be described afterwards.

The optical sheet for display use 10 described above is arranged between a light source device and liquid crystal cells, for instance, and so used as to constitute together a liquid crystal display element. In this case, an advantage of extremely simplifying the liquid crystal display element assembling can be achieved in addition to other advantages already stated (those of manufacturing an optical sheet for display use of higher quality in a simpler process and at a lower cost than the conventional practice).

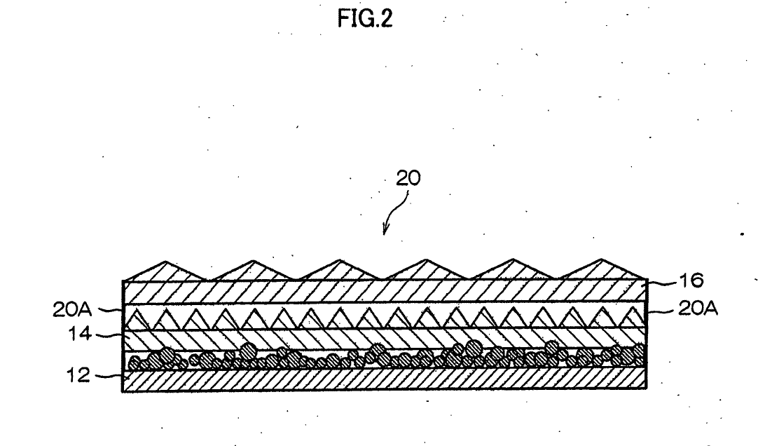

Next, another example (second example) of an optical sheet for display use according to the present invention will be described. FIG. 2 shows a section of the configuration of an optical sheet for display use 20. Incidentally, members which are the same as or similar to their counterparts in FIG. 1 (first example) will be designated by respectively the same reference signs, and their description will be omitted.

The optical sheet for display use 20 is an optical sheet configured by stacking, in an ascending order, the diffusion sheet 12, the first prism sheet 14 and the second prism sheet 16. Where an extensively diffusing performance is not required unlike the optical sheet for display use 10 described above, the second diffusion sheet 18 is omitted.

The optical sheet for display use 20 described above, like the first example, is arranged between a light source device and liquid crystal cells, for instance, and so used as to constitute together a liquid crystal display element.

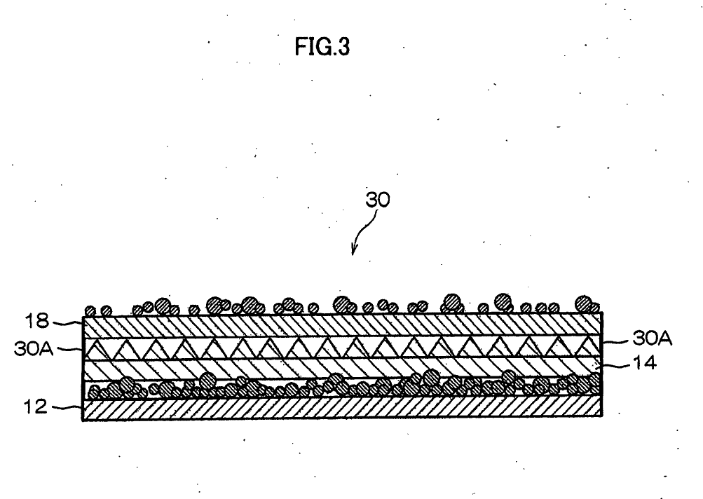

Next, still another (third example) of an optical sheet for display use according to the invention will be described. FIG. 3 shows a section of the configuration of an optical sheet for display use 30. Members which are the same as or similar to their counterparts in FIG. 1 (first example) and FIG. 2 (second example) will be designated by respectively the same reference signs, and their description will be omitted.

This optical sheet for display use 30 is an optical sheet configured by stacking, in an ascending order, the first diffusion sheet 12, the prism sheet 14 and the second diffusion sheet 18.

In the optical sheet for display use 30, where a diffusing performance in a direction perpendicular to the drawing surface is not required unlike in the optical sheet for display use 10 described above, the second prism sheet 16 is omitted.

The optical sheet for display use 30 described above, like the first example, is arranged between a light source device and liquid crystal cells, for instance, and so used as to constitute together a liquid crystal display element.

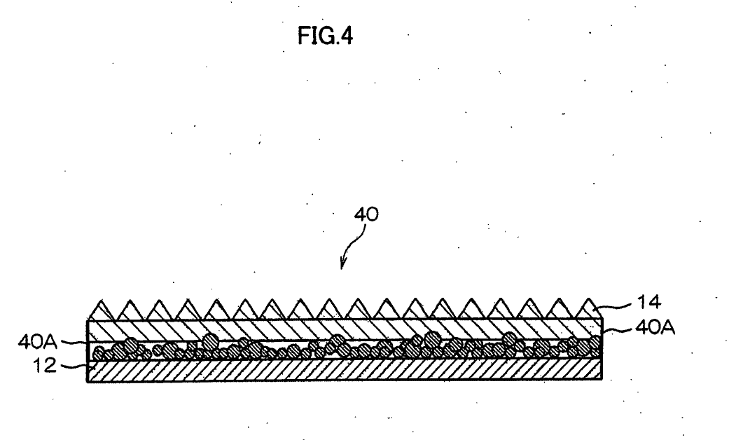

Next, still another example (fourth example) of an optical sheet for display use according to the invention will be described. FIG. 4 shows a section of the configuration of an optical sheet for display use 40. Members which are the same as or similar to their counterparts in FIG. 1 (first example) and FIG. 2 (second example) will be designated by respectively the same reference signs, and their description will be omitted.

The optical sheet for display use 40 is an optical sheet configured by stacking, in an ascending order, the diffusion sheet 12 and the prism sheet 14. Where an extensively diffusing performance is not required unlike in the optical sheet for display use 10 described above, the second diffusion sheet 18 is omitted, and where a diffusing performance in a direction perpendicular to the drawing surface is not required unlike in the optical sheet for display use 10, the second prism sheet 16 is omitted.

The optical sheet for display use 40 described above, like the first example, is arranged between a light source device and liquid crystal cells, for instance, and so used as to constitute together a liquid crystal display element.

Next, still another example (fifth example) of an optical sheet for display use according to the invention will be described. FIG. 5 shows a section of the configuration of an optical sheet for display use 50. Members which are the same as or similar to their counterparts in FIG. 1 (first example) and FIG. 2 (second example) will be designated by respectively the same reference signs, and their description will be omitted.

The optical sheet for display use 50 is an optical sheet configured by stacking, in an ascending order, the first prism sheet 14, the second prism sheet 16 and the diffusion sheet 18. Where an extensively diffusing performance is not required unlike in the optical sheet for display use 10 described above, the first diffusion sheet 12 is omitted.

The optical sheet for display use 50 described above, like the first example, is arranged between a light source device and liquid crystal cells, for instance, and so used as to constitute together a liquid crystal display element.

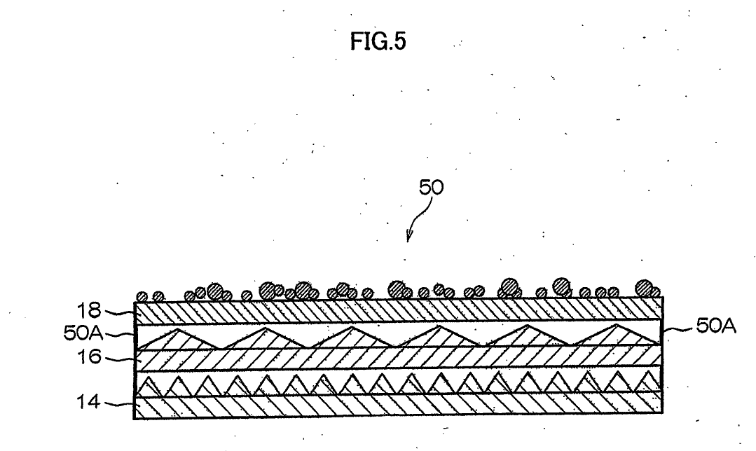

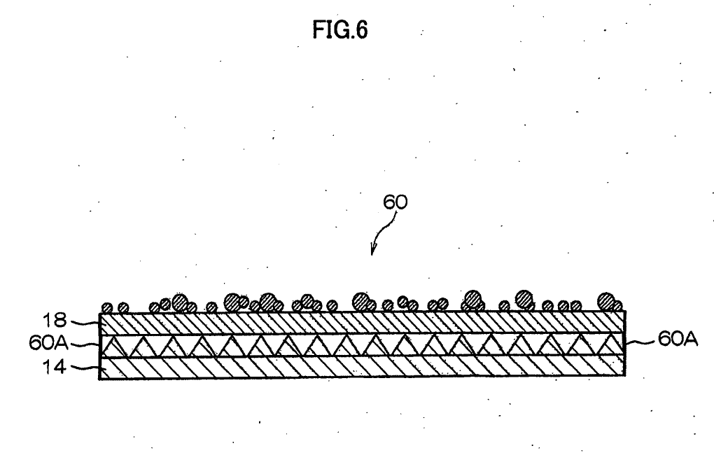

Next, still another example (sixth example) of an optical sheet for display use according to the invention will be described. FIG. 6 shows a section of the configuration of an optical sheet for display use 50. Members which are the same as or similar to their counterparts in FIG. 1 (first example) and FIG. 2 (second example) will be designated by respectively the same reference signs, and their description will be omitted.

The optical sheet for display use 60 is an optical sheet configured by stacking, in an ascending order, the first prism sheet 14 and the diffusion sheet 18. Where an extensively diffusing performance is not required unlike in the optical sheet for display use 10 described above, the first diffusion sheet 12 is omitted and, where a diffusing performance in a direction perpendicular to the drawing surface is not required unlike in the optical sheet for display use 10, the second prism sheet 16 is omitted.

The optical sheet for display use 60 described above, like the first example, is arranged between a light source device and liquid crystal cells, for instance, and so used as to constitute together a liquid crystal display element.

While there is no particular limitation to the planar dimensions of the optical sheets for display use 10 through 60 described so far, they can be matched with the size of the back light unit of the various types of display used (such as a liquid crystal display element), ranging from 127 mm (5 inches) to 1640 mm (65 inches) in diagonal length, for instance.

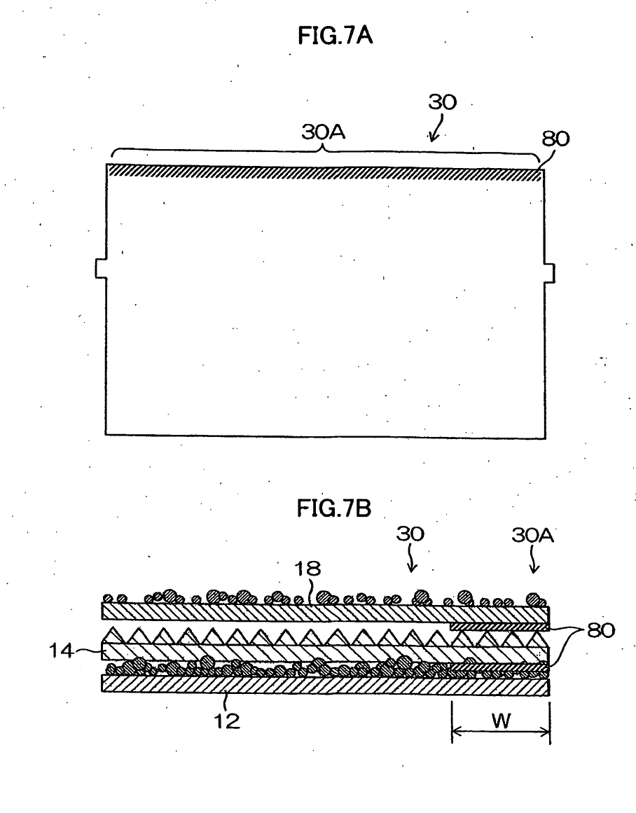

Next, the joints 10A (20A, 30A, 40A, 50A and 60A) which constitute a characteristic aspect of the invention will be described in detail. FIGS. 7A and 7B illustrate the joint 30A of the optical sheet for display use 30 (third example in FIG. 3). FIG. 7A is a plan and FIG. 7B, the right side profile of FIG. 7A.

In the optical sheet for display use 30, the joint 30A is formed by thermoadhesive films 80 on only one longer side. More specifically, as shown in FIG. 7B, the thermoadhesive films 80 of the same width W are arranged between the first diffusion sheet 12 and the prism sheet 14 and between the prism sheet 14 and the second diffusion sheet 18 along the peripheral side.

It is preferable for the width W of the thermoadhesive films 80 to be 2 to 4 mm (in the range of 2 to 4 mm from the edge). If kept in this range of width, the thermoadhesive films 80 will hardly affect the viewing range of the display device and at the same time can secure a sufficient adhesive force.

Incidentally, though the right side ends of the thermoadhesive films 80 and that of the optical sheet for display use 30 are on the same plane in the example shown in FIG. 7B, those of the thermoadhesive film 80 may as well be positioned farther inside than that of the optical sheet for display use 30.

Instead of the configuration in which the joint 30A is formed by thermoadhesive films 80 on only one longer side as shown in FIGS. 7A and 7B, it is also possible to form joints 30A on two or more sides (two opposite sides or two, three or four adjacent sides).

Or it is also possible to intermittently form joints 30A instead of forming a continuous joint 30A over the full length of a side.

It is preferable for the thickness of the thermoadhesive films 80 after adhesion to be no more than 0.1 mm. Such a thickness facilitates uniformization of the clearance between the optical sheets and serves to reduce the risk of occurrence of interference fringes.

The thermoadhesive film 80, a type of film also known as “hot melt”, is used for joining members together by heating (and pressurizing). This thermoadhesive film 80, since it has the characteristics stated in 1) through 6) below, can be suitably used for the optical sheets for display use according to the invention.

1) Its filmy composition contributes to making the adhesive layer uniform (especially uniform in thickness).

2) It can be cut in any desired shape without allowing the adhesive layer to bulge out.

3) Unlike an adhesive of any conventional type, it needs no viscosity adjustment. Nor does it require any step of drying solvent or the worker skilled in its handling.

4) There are a variety of options for the method of adhesion, including high frequency heating, ultrasonic heating and thermal pressing, any of which would readily provide a strong adhesive force.

5) As it is a hot melt type and uses no solvent, it is superior in safety aspect (emitting no foul smell to affect human health and not being inflammable).

6) It does not vary in quality or harden over time.

Available examples of such a thermoadhesive film 80 include, for instance, thermoadhesive films manufactured by Nihon Matai Co., Ltd. (product name: Elphan). Usable ones for this purpose include Elphan NT (polyamide), Elphan UH (polyurethane), Elphan PH (polyester) and Elphan OH (EVA), and Elphan PH (polyester) is particularly preferable.

Applicable methods (apparatuses) of adhering the thermoadhesive film 80 include high frequency heating (high frequency sealing apparatus), ultrasonic heating (ultrasonic sealing apparatus) and thermal pressing (heater bar heating apparatus), all referred to above.

For instance, available heating devices for thermal pressing include an impulse sealer (e.g. a product of Fuji Impulse Co., Ltd.). The preferable adhering temperature (heating temperature) of the thermoadhesive film 80 is from 110 to 230° C., though the optimum temperature varies depending on the film material and other factors.

The optical sheet for display use 30 so far described, as it uses the thermoadhesive films 80 having many features described above, does not allow occurrence of deformation (such as distortion or curling) due to mismatching among the plurality of films resulting from thermal expansion or contraction. Therefore, it is not necessary to increase the thicknesses (increase the rigidity) of individual films or to take some other measure to correct such deformation, resulting in reduced design constraints and cost saving.

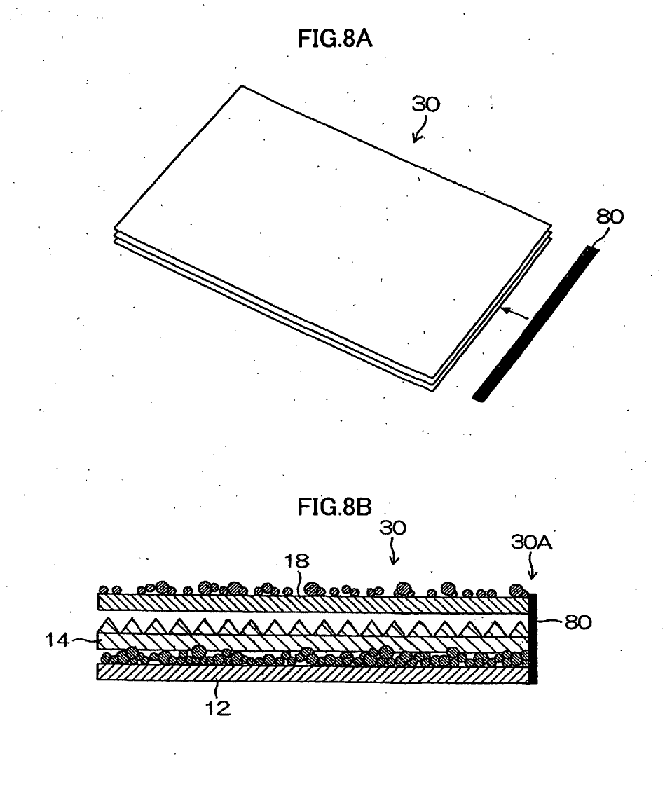

Next, another form of the joints 10A (20A, 30A, 40A, 50A and 60A) will be described. FIGS. 8A and 8B illustrate the joint 30A of the optical sheet for display use 30 (third example in FIG. 3). FIG. 8A shows a perspective view and FIG. 8B, the right side profile of FIG. 8A.

In the optical sheet for display use 30, the joint 30A is formed by the thermoadhesive film 80 on only one longer side. Specifically, as shown in FIG. 8B, the thermoadhesive film 80 is stuck to the right peripheral sides of the first diffusion sheet 12, the prism sheet 14 and the second diffusion sheet 18, and the sheets are joined with each other by this thermoadhesive film 80.

Instead of the configuration in which the joint 30A is formed by thermoadhesive films 80 on only one longer side as shown in FIGS. 8A and 8B, it is also possible to form joints 30A on two or more sides (two opposite sides or two, three or four adjacent sides).

Or it is also possible to intermittently form joints 30A instead of forming a continuous joint 30A over the full length of a side.

The same material as that used in the configuration shown in FIGS. 7A and 7B can also be used for this thermoadhesive film 80. Applicable methods (apparatuses) of adhering the thermoadhesive film 80 include high frequency heating (high frequency sealing apparatus), ultrasonic heating (ultrasonic sealing apparatus) and thermal pressing (heater bar heating apparatus), all referred to above.

In particular, as the thermoadhesive film 80 is stuck to a peripheral side of the optical sheet for display use 30 in the modes illustrated in FIGS. 8A and 8B, an apparatus of a similar configuration to apparatuses used for bookbinding, known as a thread-less biding machine or a spine-pasting machine, can be preferably used.

In the mode illustrated in FIGS. 5A and 8B, as the thermoadhesive film 80 is exposed even after the completion of the optical sheet for display use 30 unlike the earlier described configuration shown in FIGS. 7A and 7B, the thermoadhesive film 80 can be easily removed if necessary.

It is also possible in the mode illustrated in FIGS. 8A and 8B to stack in advance optical sheets for a plurality of optical sheets for display use 30, stick and join the thermoadhesive films 80 to the peripheral side of each of the plurality of optical sheets for display use 30, and afterwards cut off the thermoadhesive film 80 to separate it from each optical sheet for display use 30.

The optical sheet for display use 30 described with reference to FIGS. 8A and 8B can provide excellent effect substantially similar to the earlier version of the optical sheet for display use 30 described with reference to FIGS. 7A and 7B.

Next, a method of manufacturing the optical sheets for display use will be described. Although this manufacturing method can be commonly applied to all the optical sheets for display use 10 through 60 described so far, for the sake of convenience of explanation the following description will refer to a case in which the method is applied to a four-layered optical sheet for display use (first example).

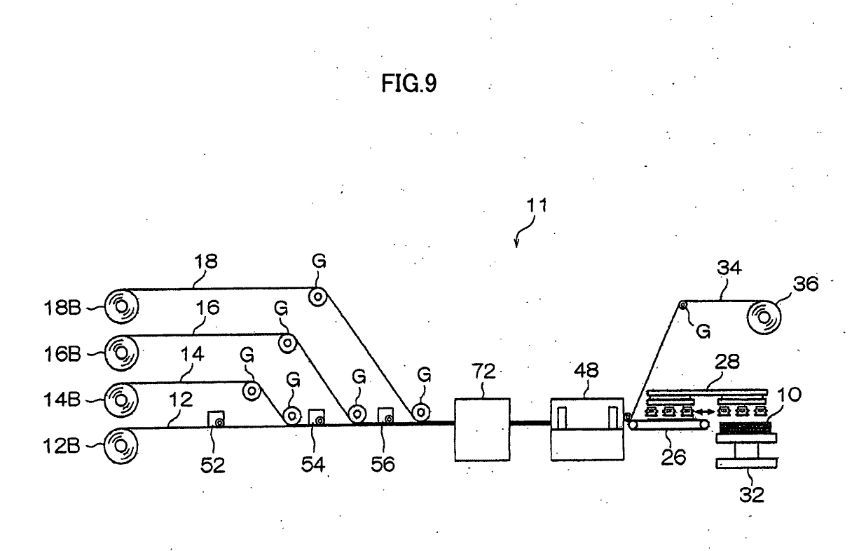

FIG. 9 shows the configuration of a manufacturing line 11 for optical sheets for display use. The first diffusion sheet 12, first prism sheet 14, second prism sheet 16 and second diffusion sheet 18 already described with reference to FIG. 1 are wound around rollers 12B, 14B, 16B and 1813 disposed at the left end of FIG. 9.

The rollers 12B, 14B, 16B and 18B are pivoted on rotation shafts of feeding means (not shown), and the first diffusion sheet 12, first prism sheet 14, second prism sheet 16 and second diffusion sheet 18 can be respectively fed out of the rollers 12B, 14B, 16B and 18B at substantially the same speeds.

The first diffusion sheet 12, first prism sheet 14, second prism sheet 16 and second diffusion sheet 18 which are fed out are supported by guide rollers G, G respectively, and eventually stacked in upstream positions from a punching press 48 to be described afterwards (stacking step). The punching press 48 is used for trimming the edges of the stacked sheet compositions to the product size.

In this manufacturing line 11 for optical sheets for display use, film feeders 52, 54 and 56 are disposed downstream from the rollers 12B, 14B, 16B and 18B. The film feeders 52, 54 and 56 feed thermoadhesive films 80 from their respective tips.

The film feeder 52 feeds the thermoadhesive film 80 onto the surface of the first diffusion sheet 12 to adhere the first diffusion sheet 12 and the first prism sheet 14 to each other; the film feeder 54 feeds the thermoadhesive film 80 onto the surface of the first prism sheet 14 to adhere the first prism sheet 14 and the second prism sheet 16 to each other; and the film feeder 56 feeds the thermoadhesive film 80 onto the surface of the second prism sheet 16 to adhere the second prism sheet 16 and the second diffusion sheet 18 to each other.

The composition of stacked sheets, each of which is fed with the thermoadhesive film 80 in the appropriate position, is delivered to an impulse sealer 72, where the joints 10A on the peripheral sides are heated and pressurized and joined with the thermoadhesive films 80.

The joined composition of stacked sheets is delivered to the punching press 48, and its edge is trimmed to fit the product size.

By going through these steps, the optical sheet for display use 10 (see FIG. 1) is formed. The optical sheet for display use 10 is carried on a conveyor 26 and stops there. Optical sheets for display use 10 on the conveyor 26 are successively stacked on a stacker 32 by a suction traversing device 28.

On the other hand, a stacked sheet composition 34 out of which the optical sheet for display use 10 has been punched by the punching press 48 is wound around a take-up roller 36 of a take-up device (details not shown).

The method of manufacturing an optical sheet for display use described above provides the effects stated in 1) through 3) below.

1) Streak Defect Reducing Effect

Any streak on the upper or lower face of a lens sheet (the first prism sheet 14 or the second prism sheet 16) would be made more conspicuous by the lens effect of the sheet. On the other hand, any streak on the lower face on a diffusion sheet (the first diffusion sheet 12 or the second diffusion sheet 18) would be made less conspicuous by the diffusion of light. For this reason, preventing streaks on lens sheets contributes to reducing streak defects. Whereas streaks often occur when handling sheets after processing, combination of a lens sheet with a diffusion sheet enables the diffusion sheet to serve as a protective sheet, and accordingly streak defects can be thereby reduced. This effect is particularly significant for the optical sheet for display use 10 of the first example (see FIG. 1) and the optical sheet for display use 30 of the second example (see FIG. 3) where no lens sheet is exposed on the surface.

2) Assembling Man-Hour Reducing Effect

Where the optical sheet for display use 10 of the first example (see FIG. 1) is used in assembling a liquid crystal display element for instance, the number of man-hours spent on assembling is the equivalent of only one step of incorporating the optical sheet for display use 10, but where conventional sheets are used, eight steps are required including the incorporation of the first diffusion sheet, removing the protective sheet on the rear face of the first lens sheet, removing the protective sheet on the front surface of the first lens sheet, incorporation of the first lens sheet, removing the protective sheet on the rear face of the second lens sheet, removing the protective sheet on the front surface of the second lens sheet, incorporation of the second lens sheet and incorporation of the second diffusion sheet. In this way, a significant reduction in the number of man-hours put into the assembling process can be reduced by the first manufacturing method, resulting in significant reduction of man-hour and a corresponding cost saving.

3) Protective Sheet Reducing Effect

In many cases, protective sheets are stuck to both faces of a lens sheet to prevent streaks. The protective sheets above are to be discarded after the lens sheet is incorporated and accordingly represent a substantial waste. The present invention can dispense with such protective sheets by using the diffusion sheet as protective sheets.

More specifically, one protective sheet each can be omitted in the optical sheet for display use 40 of the fourth example (see FIG. 4) and in the optical sheet for display use 60 of the sixth example (see FIG. 6); two in the optical sheet for display use 30 of the third example (see FIG. 3); three each in the optical sheet for display use 20 of the second example (see FIG. 2) and the optical sheet for display use 50 of the fifth example (see FIG. 5); and four in the optical sheet for display use 10 of the first example (see FIG. 1).

Next, the planar arrangement of sheets punched out of the laminate (the optical sheet for display use 10) comprising the first diffusion sheet 12, first prism sheet 14, second prism sheet 16 and second diffusion sheet 18 will be described.

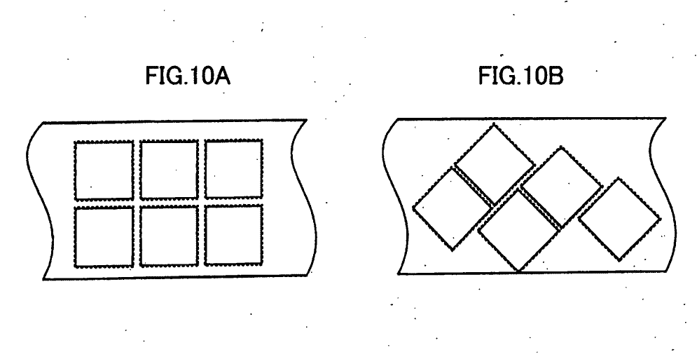

FIGS. 10A and 10B illustrate the planar arrangement of sheets punched out of the laminate (the optical sheet for display use 10).

FIG. 10A shows a state in which the sheets are cut in directions parallel and orthogonal to the direction in which the laminate is carried and FIG. 10B, a state in which they are out in a direction oblique to the same.

As so far described, optical sheets for display use of higher quality can be manufactured in a simpler process and at a lower cost according to the invention than by the conventional technique.

The invention also provides the following effects.

1) Cost Reduction and Enhanced Product Value Through Reduced Thickness

An optical sheet for use in a large liquid crystal TV set, as it has to be rigid, has supports about twice as thick as those of a conventional one. However, the optical sheet according to the invention, because of its composite structure, can be sufficiently rigid without making the constituent sheets thicker, and rather permits thinning of the individual layers.

2) Performance Improvement Through Prevention of Drop in Light Condensing Effect

Some products are matted on the rear face to prevent damaging of lens sheets (rather to make streaks less conspicuous). The optical sheet according to the invention requires no such treatment, which permits not only a saving in production cost but also an improvement in performance through the prevention of a drop in light condensing effect which would result from matting.

Examples of optical sheets for display use according to the invention in this embodiment have been described so far, but the invention is not limited to these examples but can be carried out in various other modes.

For instance, in every one of the examples described above, the prisms of the first prism sheet 14 and the second prism sheet 16 are upward, but the sheets can as well be stacked with the prisms oriented downward.

Nor is the laminated structure of the optical sheet for display use is limited to the examples described above, but protective sheets can also be stacked over the upper and lower faces, for instance. This configuration would function in the same way and provide the same effects as in any of the foregoing embodiment.

### Second Embodiment for Carrying Out the Invention

A second embodiment for carrying out the invention will be described below with reference to accompanying drawings. Incidentally, the configuration of the examples the optical sheet for display use of the laminated sheet composition type (first through sixth examples) is the same as that in the first embodiment described with reference to FIG. 1 through FIG. 6, and will be described by using the same corresponding signs.

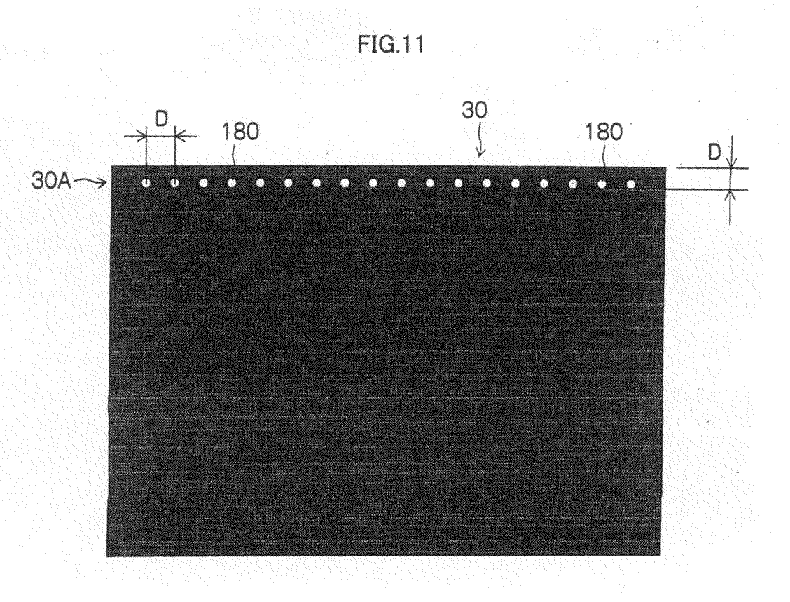

Details of the joints 10A (20A, 30A, 40A, 50A, and 60A) which constitute characteristic parts of the second embodiment will be described. FIG. 11 is a plan illustrating a joint 30A of the optical sheet for display use 30 (third example shown in FIG. 3). In this optical sheet for display use 30, the joint 30A is formed on only one long side (top side) by a plurality of through holes 180, 180 . . . .

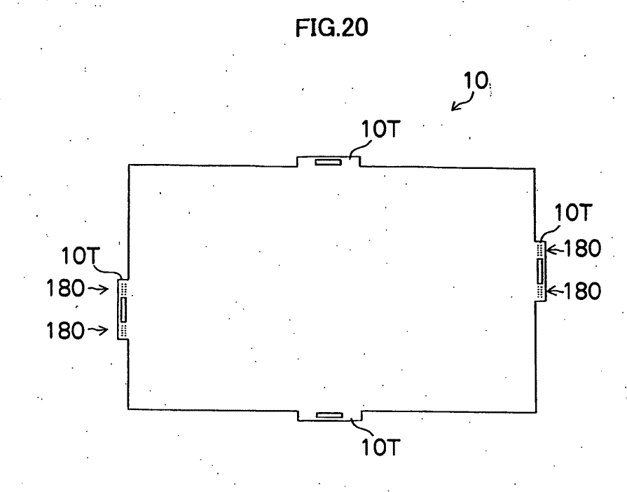

Incidentally, though there are preferable positions for the plurality of through holes 180, 180 . . . to be formed as will be described afterwards with reference to FIG. 20 through FIG. 23, the description here will refer to a simple hole arrangement for the sake of convenience of description.

It is preferable for the through holes 180 to be so formed that the distance D between the edge of the optical sheet for display use 30 and the farthest inside edge of the sheet of through holes 180 is not more than 5 mm, and more preferable for D to be not more than 3 mm. Formation of the through holes 180 in such positions makes the viewing range of the display device practically immune from adverse effects and enables a sufficient adhesive force to be secured.

The optimal pitch P of the through holes 180, 180 . . . varies with the size and configuration of the optical sheet for display use 30 (the optical sheet for display use 10, 20, 40, 50 or 60). Where the pitch P is too small, the corrugating deformation of the sheets is apt to give rise to interference fringes, and therefore it is preferable for the pitch P to be no less than 10 mm in a linear arrangement as shown in FIG. 11. On the other hand, though there is no upper limit to the pitch P, too large a pitch might adversely affect the state of engagement between optical sheets.

Incidentally, instead of the configuration in which the joint 30A is formed on only one longer side as in the configuration shown in FIG. 11, it is also possible to form joints 30A on two or more sides (two opposite sides or two, three or four adjacent sides).

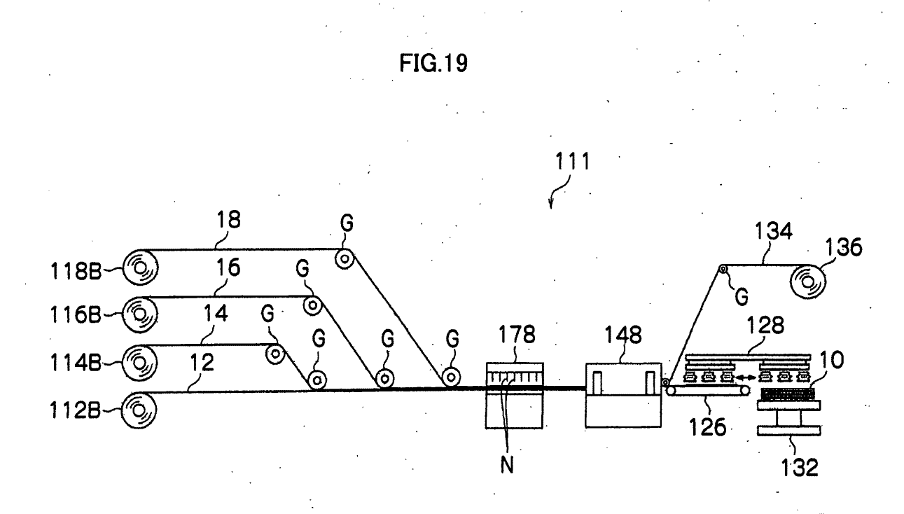

Next, the device (apparatus) for forming the through holes 180, 180 . . . will be described. Incidentally, though a manufacturing line 111 for optical sheets for display use to be described afterwards with reference to FIG. 19 uses an automated through hole boring device 178, a simple manual apparatus will be described here to facilitate understanding.

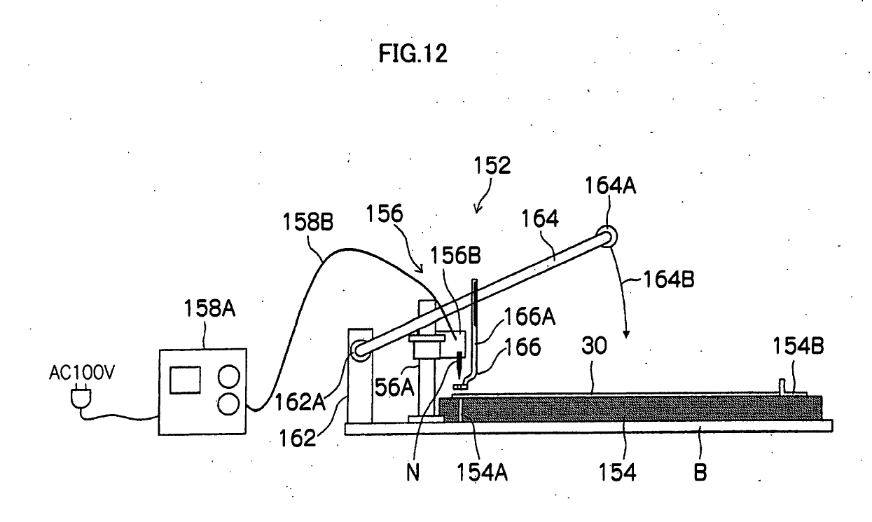

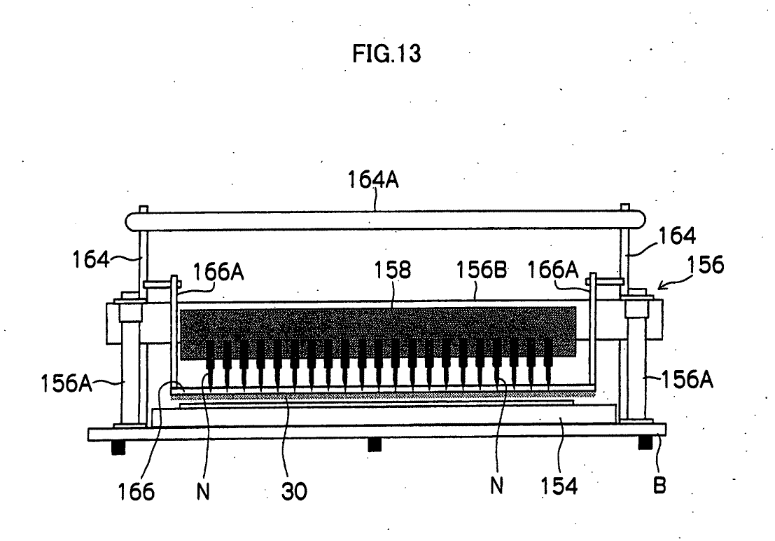

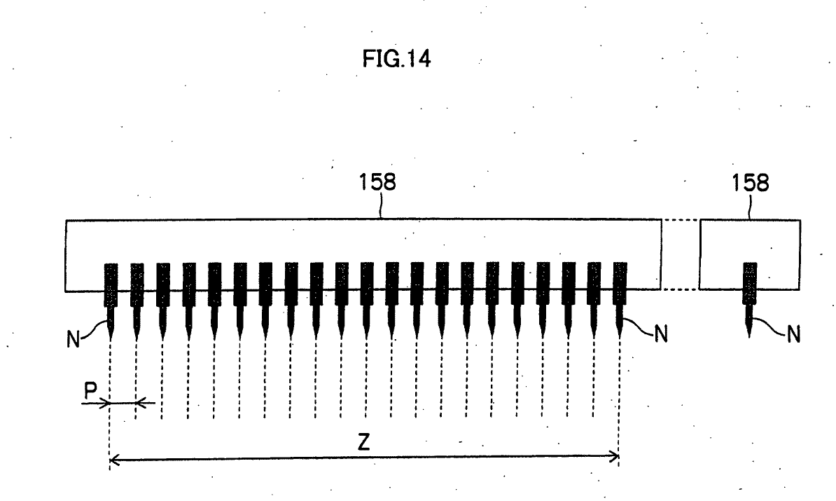

FIG. 12 shows the overall configuration of a manual through hole boring device 152 while FIG. 13 shows a right side profile of the same and FIG. 14, a partial enlarged view of FIG. 13. This apparatus is provided with a table 154 for holding the optical sheet for display use 30 (10, 20, 40, 50, 60), an elevating stage 156 for moving up and down a plurality of acicular members N, N . . . , and a heater block 158 (see FIG. 13 and FIG. 14), which is a device for heating the acicular members N, N . . . , and enables through holes 180, 180 . . . to be formed by the acicular members N, N . . . heated in a plurality of positions on the edge of the laminate of optical sheets.

The table 154, fixed over the base B of the apparatus, has a flat surface (top face). An escape hole 154A is formed near the left edge of this table, and a sheet stopper 154B is formed near the right edge. Details of the escape hole 154A and sheet stopper 154B will be described afterwards.

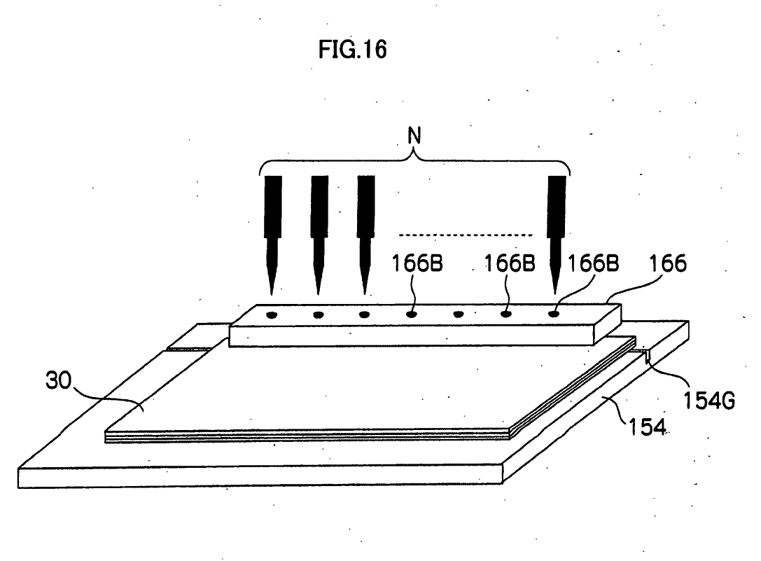

The elevating stage 156 is composed, as it is shown in FIG. 13, of struts 156A and 156A stood to the right and left of the base B and a stage 156B supported by the struts 156A and 156A to be movable up and down. Incidentally, the stage 156B is urged upward by a spring device (not shown) and, as shown in FIG. 16, the tips of the acicular members N, N . . . are in upper positions where they do not come into contact with the optical sheet for display use 30.

As shown in FIG. 13, the heater block 158 is fixed to the stage 156B, and the acicular members N, N . . . are fixed to the heater block 158 at a prescribed pitch P as shown in FIG. 13 and FIG. 14.

An electric heater (not shown) is embedded in this heater block 158, and electric power is supplied to this electric heater from a heater controller 158A shown in FIG. 12 via a power supply cable 158B.

Referring to FIG. 12, an arm stand 162 is erected near the left end of the base B, and one end (left end) each of arms 164 and 164 is rotatably supported by a fulcrum 162A provided in the upper part of this arm stand 162.

An arm handle 164A is fitted to the other ends (right ends) of the arms 164 and 164, and the arms 164 and 164 at the two ends turn in association with this arm handle 164A.

Parts toward the left ends of these the arms 164 and 164 are engaged with the upper part of the stage 156B. By pressing down the arm handle 164A in the direction of the arrow 164B in FIG. 12, the stage 156B is moved downward, and the tips of the acicular members N, N . . . can be moved to positions where they can penetrate the optical sheet for display use 30.

The acicular members N, N are fixed to the heater block 158 as their front and right profile in FIG. 14 show to ensure good thermal conduction from the heater block 158. The pitch P of the acicular members N, N . . . was already discussed with reference to FIG. 11. The zone Z in which the acicular members N, N . . . are disposed can be determined as appropriate relative to the width of the optical sheet for display use 30 which they are to penetrate.

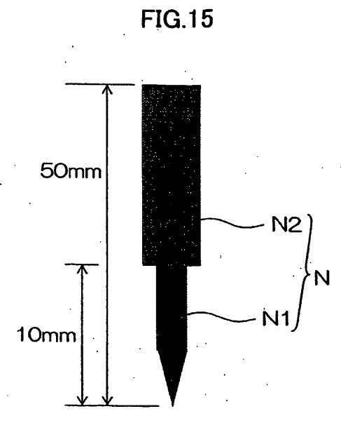

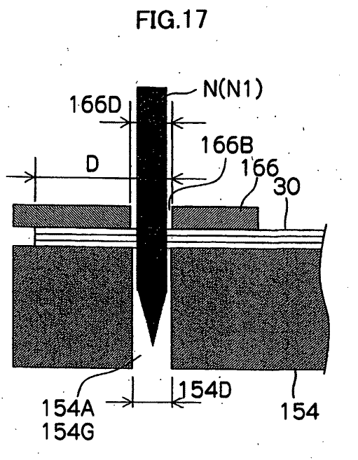

FIG. 15 shows details of an acicular member N; FIG. 16, a perspective view of the positional relationship between the acicular members N, N . . . and a holding plate 166, which is an upper holding member; and FIG. 17, a state in which an acicular member N penetrates the optical sheet for display use 30. Referring to FIG. 16, an escape groove 154G is cut the table 154 (corresponding to a lower holding member) in place of the escape hole 154A. This escape groove 154G provides a similar effect to the escape hole 154A.

Although there is no particular limitation to the material of the acicular member N, copper excelling in thermal conduction is preferable, and bronze also excelling in thermal conduction is preferable next to copper. Incidentally, commercially available soldering iron tips can be used as acicular members N.

There is no particular limitation to the shape of acicular member N either, but a two-step configuration, such as the one shown in FIG. 15, comprising a tip N1 of a relatively small diameter penetrating the optical sheet for display use 30 and a base end N2 greater than the tip N1 in diameter is preferable in respect of strength and thermal conduction. The lengths of the tip N1 and the base end N2 may be 10 mm and 40 mm, respectively, as shown in FIG. 15.

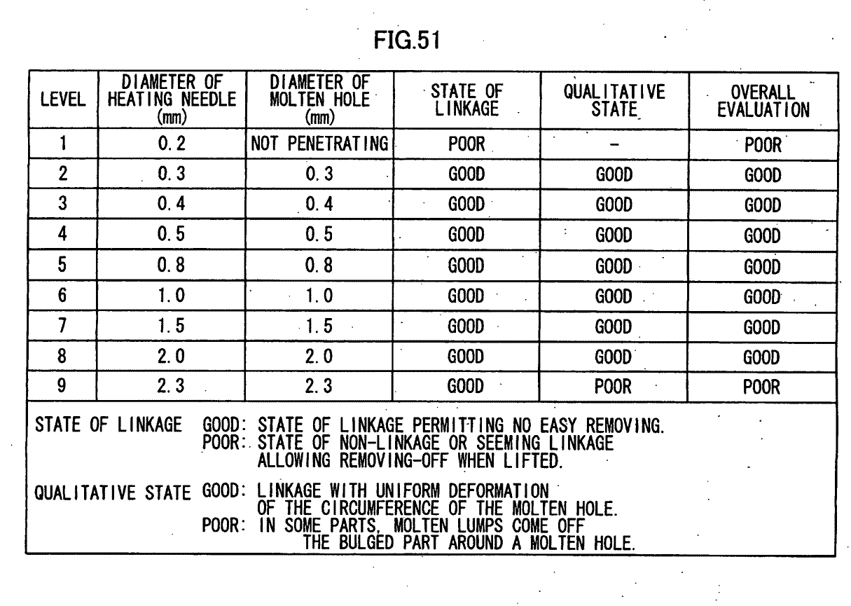

It is preferable to form the end of the tip N1 in a conic shape, because a conic shaped tip can easily penetrate the optical sheet for display use 30. There is no particular limitation to the diameter of the tip N1 either, but if it is too small as in an example to be described afterwards (see the table in FIG. 51), the molten volume of resin will be insufficient, giving no adequate linking effect, while too large a diameter would cause the molten part of resin to intrude into the image display area of the optical sheet for display use 30, both undesirable. Therefore, it is preferable for the diameter of the tip N1 to be in a range of 0.3 to 2.0 mm.

Where the diameter of the tip N1 is relatively small (e.g. 0.3 mm), forming the end of the tip N1 straight, instead of conic, would result in no significant difference in effect.

As shown in FIG. 16 and FIG. 17, insertion holes 166B to let the tips N1 of the acicular members N penetrate are formed in the holding plate 166. Also as shown in FIG. 17, interference between the acicular members N and the table 154 is prevented by the escape hole 154A (the escape groove 154G) formed in the table 154 as already described. Referring to FIG. 17, in a state in which the acicular members N penetrate the optical sheet for display use 30, their farther descent is prevented by a stopper (not shown). Incidentally, symbol D in FIG. 17 is the same as the distance D in the context of FIG. 11.

As the configuration shown in FIG. 17 enables the holding plate 166 (corresponding to the upper holding member) and the table 154 (corresponding to the lower holding member) to squeeze the edges of the acicular members N with no gap, it is made difficult for molten parts of the optical sheet for display use 30 to enter between the optical sheets and give rise to distortion or interference fringes in the sheet composition.

It is preferable for the bore 166D of the insertion holes 166B and/or the bore 154D of the escape hole 154A (the width of the escape groove 154G) to be 1.02 to 4 times the diameter of the acicular members N. Such a hole bore 166D and/or groove width 154D would allow squeezing of the edges of the acicular members N with no gap. It is preferable for the hole bore 166D and/or groove width 154D to be 1.5 to 3 times the diameter of the acicular members N, and more preferable to be 1.8 to 2.5 times the diameter of the acicular member N.

It is preferable for the squeezing force working on the holding plate 166 and the table 154 to be 0.2 Pa to 6.0 Pa. Such a squeezing force would enable the edges of the acicular members N to be squeezed with no gap and the surface pattern of the optical sheets to be prevented from being damaged. It is preferable for this squeezing force to be 0.4 Pa to 4.0 Pa and more preferable to be 0.6 Pa to 3.0 Pa.

Referring to FIG. 12 and FIG. 13 already discussed, holding plate arms 166A and 166A provided at their lower ends with the holding plate 166 are so disposed as to be engaged with the vicinities of the central parts of the arms 164 and 164. This holding plate 166, as described above, is a member which restricts the movement of the optical sheet for display use 30 when the acicular members N penetrate the optical sheet for display use 30 by pressing the optical sheet for display use 30. The holding plate arms 166A and 166A are so disposed as to be engaged with the arms 164 and 164 and to be moved up and down by the turning of the arms 164 and 164.

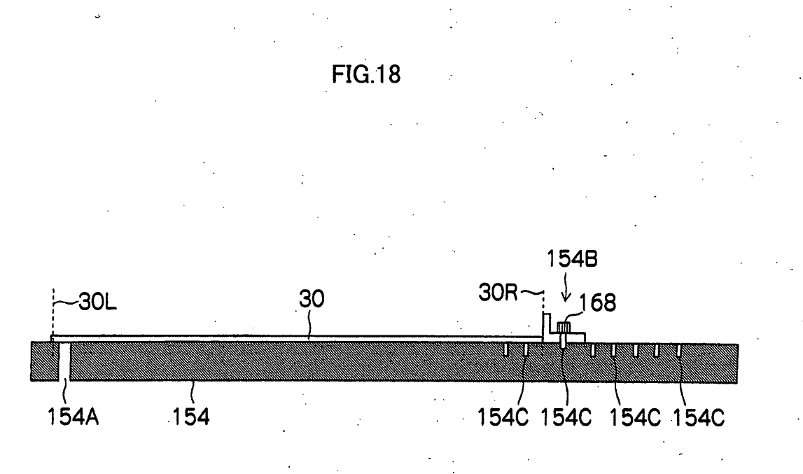

Next, details of the sheet stopper 154B will be described. FIG. 18 shows a section of the table 154. This sheet stopper 154B is a member for restriction the movement of the optical sheet for display use 30. By pressing the right end 30R of the optical sheet for display use 30 against the left end of the sheet stopper 154B, the position of the left end 30L of the optical sheet for display use 30 is restricted.

This sheet stopper 154B is a long member whose section is L-shaped (angle member). By inserting a bolt member 168 into a through hole (not shown) and screwing this bolt member 168 into a tapped hole 154C into the table 154, the sheet stopper 154B is fixed to the table 154.

Incidentally, as shown in FIG. 18, a plurality of tapped holes 154C, 154C . . . are formed in the table 154 to make the table 154 adaptable to optical sheets for display use 30 of different sizes.

Next, a method of engaging optical sheets with each other by using the through hole boring device 152 described above will be described mainly with reference to FIG. 12.

Before engaging them, the sheet stopper 154B is set in its appropriate position. Also, the heater block 158 is set at its appropriate temperature with the heater controller 158A. This temperature, varying with the material of the optical sheets, should be not lower than the melting point of PET (253 to 258° C.) if the support of the optical sheets is polyethylene terephthalate (PET). However, if the temperature is relatively low even though not below this melting point, it is preferable for the temperature to be not less than 265° C. because of the problem that molten matter tends to remain as dregs between the support of the optical sheets and the acicular members N (trouble of stickiness).

If the set temperature is too high, the whole apparatus should be made sturdy enough to stand that high temperature. However, by making a structure heated locally such as a soldering iron to permit setting a high temperature of up to 480° C., the whole apparatus need not be built sturdy enough to stand high temperature, and accordingly can be fabricated at low cost. Moreover, if the set temperature is too high, the support (PET) will more intensely, inviting a quality problem of disturbing the shape of the through holes 180. Therefore, it is preferable for the set temperature of the heater block 158 to be no higher than 300° C.

In the engaging procedure, first the optical sheet for display use 30 is set on the table 154. At this step, the optical sheet for display use 30 is positioned by pressing its right end 30R to the left end part of the sheet stopper 154B (see FIG. 18).

Then, the arm handle 164A is pressed down in the direction of the arrow 164B in FIG. 12. This causes first the holding plate 166 to press the optical sheet for display use 30 to restrict the movement of the optical sheet for display use 30. Then, the stage 156B moves downward to cause the tips of the acicular members N, N . . . to penetrate the optical sheet for display use 30 and to stop in the position indicated in FIG. 17. In this state, the optical sheets around the edges of the acicular members N are molten.

Next, the arm handle 164A is thrust upward in the direction reverse to the direction of the arrow 164B in FIG. 12. This causes first the tips of the acicular members N, N . . . to come off the optical sheet for display use 30, and then the holding plate 166 releases the optical sheet for display use 30 from pressure.

In this state, the molten parts of the optical sheets are solidified. In this process, the upper and lower optical sheets are joined with each other by the solidified molten parts to integrate the plurality of optical sheets with one another.

As the through holes 180 are formed in more than one positions on the edge of the laminated sheet composition and the optical sheets are engaged with one another by the through holes 180 by the hitherto described method of engaging the optical sheets with one another by using the through hole boring device 152, the step of cutting a number of films (sheets) separately into the product size can be omitted, and so can be the step of stacking multiple layers of films (sheets) while positioning them. Also, it is free from the above-noted problem which derives from protective sheets, resulting in advantages in both cost and quality aspects. Moreover, it is free from the aforementioned problem which arises when multiple layers of films are stacked.

Also, as mismatching among the plurality of films due to thermal expansion or contraction is eased by the engaging of the through holes 180 formed at intervals, deformation (such as distortion or curling) due to mismatching hardly occurs. Therefore, it is not necessary to increase the thicknesses (increase the rigidity) of individual films or to take some other measure to correct such deformation, resulting in reduced design constraints and cost saving.

For the reasons so far described, the laminated sheet compositions of higher quality for display use such as liquid crystal display elements and the like can be manufactured in a simpler process and at a lower cost according to the invention than by the conventional technique.

Next, a method of manufacturing an optical sheet for display use in a mode in which the engaging of the optical sheets with one another by using the through hole boring device 152 is automated will be described. Although this manufacturing method is applicable commonly to all the optical sheets for display use 10 through 60 already described, for the sake of convenience of explanation the following description will refer to a case in which the method is applied to a four-layered optical sheet for display use (first example).

FIG. 19 shows the configuration of the manufacturing line 11 for optical sheets for display use. Rollers 112B, 114B, 116B and 118B shown toward the left end of the drawing are the rollers around which the first diffusion sheet 12, first prism sheet 14, second prism sheet 16 and second diffusion sheet 18 of the already described first embodiment shown in FIG. 1 are respectively wound.

The rollers 112B, 114B, 11613 and 118B are pivoted on the rotation shafts of feeding devices (not shown), and the first diffusion sheet 12, first prism sheet 14, second prism sheet 16 and second diffusion sheet 18 can be fed out of the rollers 112B, 114B, 116B and 118B, respectively, at substantially equal speeds.

The first diffusion sheet 12, first prism sheet 14, second prism sheet 16 and second diffusion sheet 18, which have been fed out, are supported by respective guide rollers G, G . . . , and eventually stacked one over another on the upstream side of the through hole boring device 178 (stacking step). A punching press 148 is used downstream from the through hole boring device 178 to trim the edge of the laminate to fit the product size.

The automated through hole boring device 178, which operates on the same principle as the manual through hole boring device 152 already described, moves up and down the acicular members N, N . . . automatically with a cylinder device (not shown) instead of manually with the arm handle 164A. It is provided with an orthogonal robot or the like for use in positioning any of the optical sheets for display use 10 through 60 and other purposes.

Through holes 180 are formed by this through hole boring device 178, and the laminated sheet composition comprising the optical sheets engaged with one another by the through holes 180 are delivered to the punching press 148 to undergo trimming of the edges to fit the product size.

By going through the process described above, the optical sheet for display use 10 (see FIG. 1) is formed. This optical sheet for display use 10 is carried on a conveyor 126, and stops there. Optical sheets for display use 10 on the conveyor 126 are successively stacked on a stacker 132 by a suction traversing device 128.

On the other hand, the laminated sheet composition 134 from which optical sheets for display use 10 have been punched out by the punching press 148 is taken up around a take-up roller 136 of a take-up device (details not shown).

The method of manufacturing an optical sheet for display use so far described (including the earlier described manual manufacturing method) can achieve 1) the streak defect reducing effect, 2) assembling man-hour reducing effect and 3) protective sheet reducing effect, and the description of details of these effects is omitted because they are similar to those of the first embodiment. Also, the planar arrangement of sheets (the optical sheets for display use 10) punched out of the laminate of the first diffusion sheet 12, first prism sheet 14, second prism sheet 16 and second diffusion sheet 18 is also similar to that in the first embodiment described with reference to FIGS. 10A and 10B.

Next, preferable positions for the formation of the through holes 180, 180 . . . will be described with reference to FIG. 20 through FIG. 23. Though the embodiment illustrated in FIG. 11 can achieve the effects of the invention as described above, a more preferable result can be obtained by arranging two or more per cm² of through holes 180, 180 . . . in the parts where optical sheets are engaged with one another. It is more preferable for the density of the through holes 180, 180 . . . to be 4/cm² and even more preferable to be 6/cm².

FIG. 20 is a plan of the optical sheet for display use 10. This optical sheet for display use 10 is equivalent to 813 mm (32 inches) in diagonal length, and has tabs 10T as catches, one at the center of each of the four sides. The through holes 180, 180 . . . are formed in the tabs 10T on the two short sides.

The through holes 180, 180 . . . are provided in two rows, upper and lower, in a density of 6.25/cm². By arranging in this way the through holes 180, 180 . . . in the catches (the tabs 10T), where the mutual engagement of the optical sheets is more susceptible to release, the effects of the invention can be achieved more significantly.

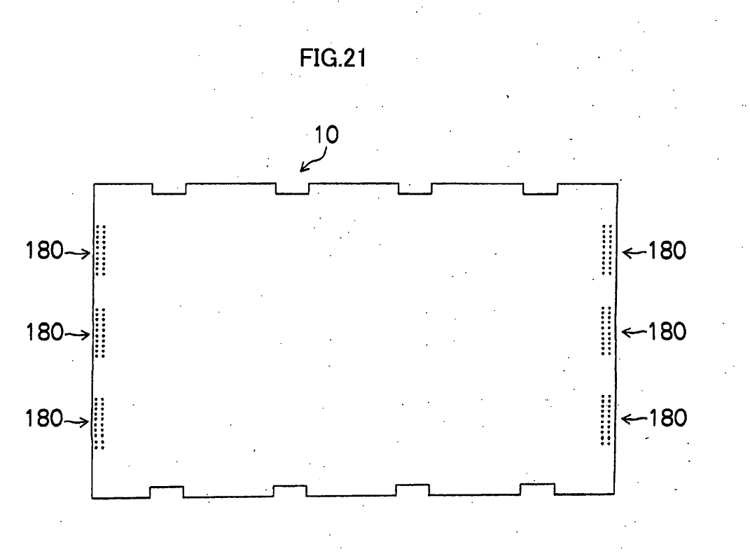

FIG. 21 is a plan of another optical sheet for display use 10. This optical sheet for display use 10 is equivalent to 1143 mm (45 inches) in diagonal length, and has a plurality of notches in both of its long sides. The through holes 180, 180 . . . are formed in the two short sides.

The through holes 180, 180 . . . are provided in two rows, upper and lower, in there positions in a density of 6.25/cm². By arranging in this way the through holes 180, 180 . . . in the short sides which can serve as catches, where the mutual engagement of the optical sheets is more susceptible to release, the effects of the invention can be achieved more significantly.

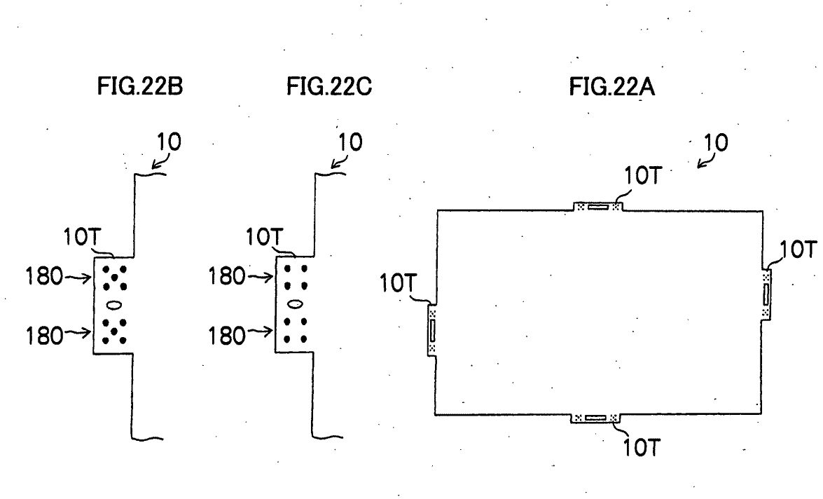

FIG. 22A is a plan of still another optical sheet for display use 10. This optical sheet for display use 10 is equivalent to 660 mm (26 inches) to 813 mm (32 inches) in diagonal length, and has the tabs 10T, one at the center of each of the four sides. The through holes 180, 180 . . . are formed in the tabs 10T on the respective sides. FIGS. 22B and 22C show enlarged views of the vicinities of the tab 10T in the left short side.

The through holes 180, 180 . . . are fowled in two positions in each of the tabs 10T, arranged in the pattern of five spots on a die in FIG. 22B in a density of 8/cm². In FIG. 22C, they are arranged in the pattern of four spots on a die in FIG. 22B in a density of 4/cm². By arranging in this way the through holes 180, 180 . . . in the catches (the tabs 10T), where the mutual engagement of the optical sheets is more susceptible to release, the effects of the invention can be achieved more significantly.

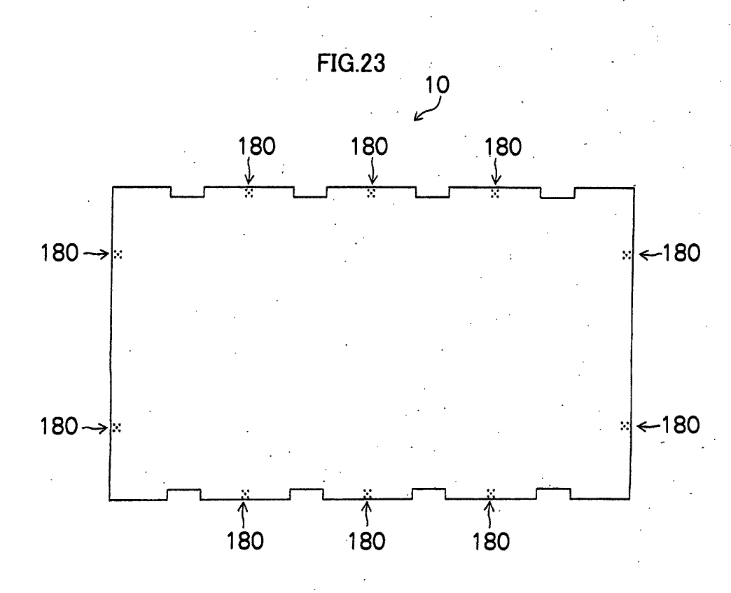

FIG. 23 is a plan of still another optical sheet for display use 10. This optical sheet for display use 10 is equivalent to 1143 mm (45 inches) in diagonal length, and has a plurality of notches in both of its long sides. The through holes 180, 180 . . . are formed in each side.

The through holes 180, 180 . . . are provided in two positions in the short sides and three positions in long sides. They are arranged in the pattern of five spots on a die in a density of 12.5/cm². By arranging in this way the through holes 180, 180 . . . in the sides which can serve as catches, where the mutual engagement of the optical sheets is more susceptible to release, the effects of the invention can be achieved more significantly.

As so far described, optical sheets of higher quality for display use can be manufactured in a simpler process and at a lower cost according to the invention than by the conventional technique.

According to the invention, as described with reference to the first embodiment, 1) cost reduction and an enhanced product value through reduced thickness and 2) performance improvement through prevention of a drop in light condensing effect can be achieved. Details are similar to those of the first embodiment.

Examples of optical sheet for display use according to the invention in this embodiment have been described so far, but the invention is not limited to these examples but can be carried out in various other ways.

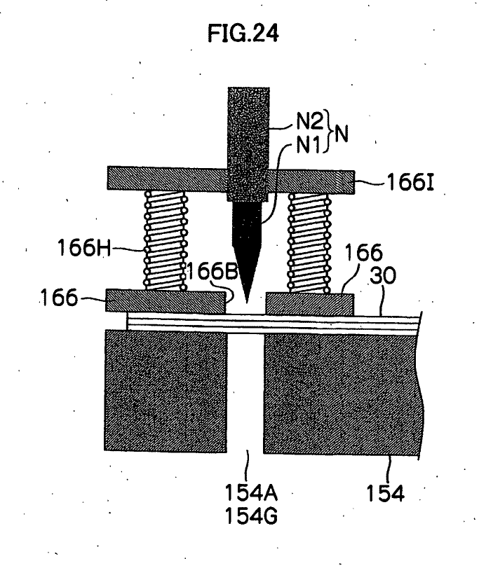

For instance, though the positional relationship between the acicular members N, N . . . and the holding plate 166 is supposed to be as shown in FIG. 17, it can be in some other configuration. FIG. 24 shows another example of configuration corresponding to FIG. 17. In this configuration, a top plate 166I is fixed to the base end N2 of the acicular member N, and the holding plate 166 is supported by the top plate 166I via spring members 166H and 166H.

In this configuration, the holding plate 166 presses the optical sheet for display use 30 via the spring members 166H and 166H along with the descent of the acicular member N. Therefore, the holding plate arms 166A and 166A shown in FIG. 12 and elsewhere are not required.

In every example of the second embodiment described above, the prisms of the first prism sheet 14 and the second prism sheet 16 are supposed to be upward, but the sheets can as well be stacked with the prisms oriented downward.

Nor is the laminated structure of the optical sheet for display use is limited to the examples described above, but protective sheets can also be stacked over the upper and lower faces, for instance.

This configuration would function in the same way and provide the same effects as in this second embodiment.

### Third Embodiment for Carrying Out the Invention

A third embodiment for carrying out the invention will be described below with reference to accompanying drawings. Incidentally, the configuration of the example of the optical sheet for display use of the laminated sheet composition type (first through sixth examples) is the same as that in the first embodiment described with reference to FIG. 1 through FIG. 6, and will be described by using the same corresponding signs.

A manufacturing method 200 for optical sheets for display use according to the invention will be described. Although this manufacturing method is applicable commonly to all the optical sheets for display use 10 through 60 already described, for the sake of convenience of explanation the following description will refer to a case in which the method is applied to a three-layered optical sheet for display use (third example).

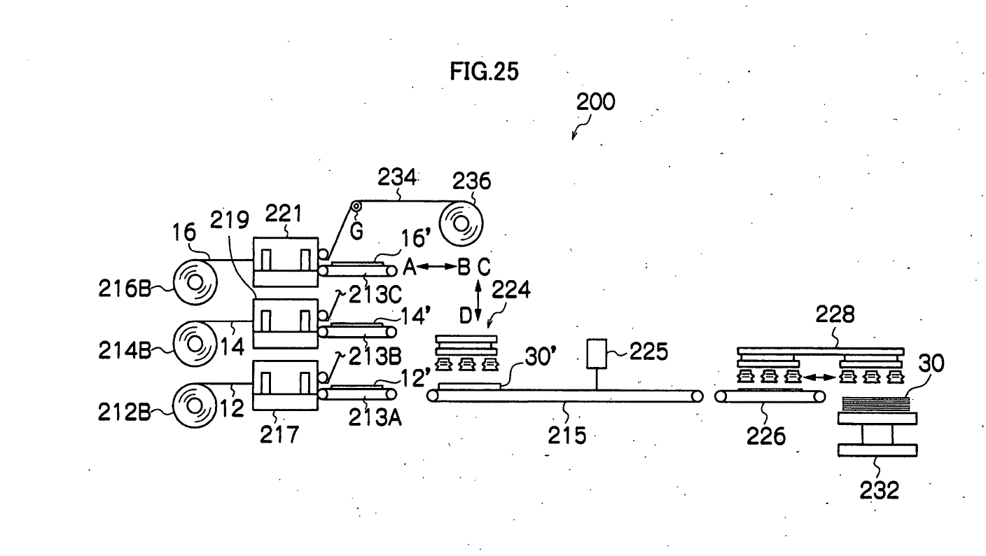

Rollers 212B, 214B and 216B shown toward the left end of FIG. 25 are the rollers around which the first diffusion sheet 12, prism sheet 14 and second diffusion sheet 16 of the already described first embodiment shown in FIG. 3 are respectively wound.

The rollers 212B, 214B and 216B are pivoted on the rotation shafts of feeding devices (not shown), and the first diffusion sheet 12, prism sheet 14 and second diffusion sheet 16 can be fed out of the rollers 212B, 214B and 216B, respectively, at substantially equal speeds.

The first diffusion sheet 12, prism sheet 14 and second diffusion sheet 16, which have been fed out, are punched by respective punching presses 217, 219 and 221 arranged downstream into a prescribed planar size or a prescribed shape (or undergo formation of notches or holes) (punching step). On the other hand, a sheet residual 234 remaining after the punching, guided by the guide roller G, is taken up around a take-up roller 236 of a take-up device (details not shown). Incidentally, FIG. 25 shows the take-up roller 236 of only the sheet residual 234 of the second diffusion sheet 16, and the illustration of winding up sheet residuals from the first diffusion sheet 12 and the prism sheet 14 is omitted.

Next, a first diffusion sheet 12′, a prism sheet 14′ and a second diffusion sheet 16′ punched into a prescribed planar size or a prescribed shape, after being discharged onto respective conveyors 213A, 213B and 213C, are stacked by a suction robot 224 onto the next joining conveyor 215 (stacking step). The suction robot 224, which can move transversely (in the A-B direction in FIG. 25) and perpendicularly (the C-D direction in FIG. 25), stacks the sheets mounted on the conveyors 213A, 213B and 213C on the joining conveyor 215 in the ascending order of the first diffusion sheet 12′, prism sheet 14′ and second diffusion sheet 16′. A pre-joined laminated sheet composition 30′ is thereby formed.

Then at the joining step, the laminated sheet composition 30′ is integrated by joining only the top layer second diffusion sheet 16′ and the bottom layer first diffusion sheet 12′ of the laminated sheet composition 30′ by a joining device 225 (joining step). As the joining device 225, a welding means such as an impulse sealer (sealer which performs heating by causing an electric current to momentarily flow), laser irradiating device, high-frequency welding device or ultrasonic welding device, an adhesive, a double-sided adhesive tape or the like can be used. A joined laminated sheet composition 30 (optical sheet for display use) is thereby fabricated. Joined laminated sheet compositions 30 are transferred from the joining conveyor 215 to a transfer conveyor 226, and successively mounted on a stacker 232 by a suction traversing device 228.

The method of manufacturing an optical sheet for display use so far described can achieve 1) the streak defect reducing effect, 2) assembling man-hour reducing effect and 3) protective sheet reducing effect, but the description of details of these effects is omitted because they are similar to those of the first embodiment. Also, the planar arrangement of sheets (the optical sheets for display use 10) punched out of the laminate of the first diffusion sheet 12, first prism sheet 14, second prism sheet 16 and second diffusion sheet 18 is also similar to that in the first embodiment described with reference to FIGS. 10A and 10B.

According to the invention, as described with reference to the first embodiment, 1) cost reduction and an enhanced product value through reduced thickness and 2) performance improvement through prevention of a drop in light condensing effect can be achieved. Details are similar to those of the first embodiment.

Next, the modes in which only the top layer second diffusion sheet 16′ and the bottom layer first diffusion sheet 12′ by the joining device 225, out of the first diffusion sheet 12′, prism sheet 14′ and second diffusion sheet 16′ punched into the prescribed planar size or the prescribed shape at the punching step, are joined (first through sixth modes) will be described.

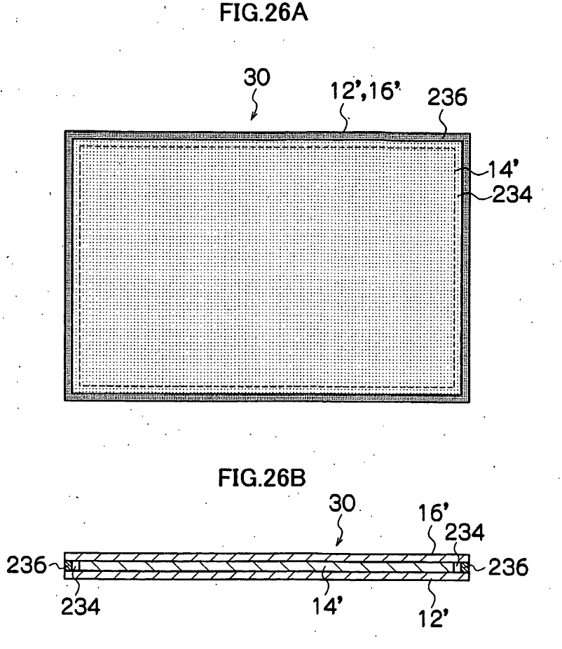

FIGS. 26A and 26B illustrate a first mode, wherein the punching step is so accomplished as to make the planar size of the prism sheet 14′ of the intermediate layer between the top layer first diffusion sheet 16′ and the bottom layer second diffusion sheet 12′ smaller than the planar size of the top layer and in the bottom layer, and in the joining step, the whole edges around the top layer and bottom layer diffusion sheets 16′ and 12′ are joined to internally contain the prism sheet 14′ of the intermediate layer. In the joining procedure, heating may be first applied from the top layer diffusion sheet 16′ side, followed by heating from the bottom layer diffusion sheet 12′ side (the same applies to the second through sixth mode).

The optical sheet for display use, which is the laminated sheet composition 30, is thereby integrated in the form of holding the prism sheet 14′ of the intermediate layer between the top layer and bottom layer diffusion sheets 16′ and 12′. Therefore, as the prism sheet 14′ of the intermediate layer is only held between but not joined to the top layer and bottom layer diffusion sheets 16′ and 12′, bending (such as distortion or curling) of the laminated sheet composition 30 will hardly occur itself even if there is any difference in thermal expansion or contraction among the plurality of sheets 12′, 14′ and 16′.

Or, by joining only the top layer and bottom layer diffusion sheets 16′ and 12′, the generation of molten matter from sheets can be reduced compared with its volume arising from the welding of all the sheets 12′, 14′ and 16′ including the intermediate layer even where joining is accomplished by welding by an impulse sealer, for example. Any known appropriate impulse sealer can be used, such as the product of Fuji Impulse Co., Ltd.

This serves to eliminate the problem that molten matter bulges out of the laminated sheet composition 30 to change the post-joining dimensions of the laminated sheet composition 30. Furthermore, by making the planar size of the prism sheet 14′ of the intermediate layer smaller than the planar size of the top layer and bottom layer diffusion sheets 12′ and 16′, an annular gap 234 is formed between the edge of the top layer and that of the bottom layer which are joined, and molten matter 236 occurring in the joining process is accommodated into this gap 234, with the result that the molten matter 236 is made even more difficult to bulge out of the laminated sheet composition 30. Incidentally, though the commonest planar shape of the top layer, the bottom layer and the intermediate layer is rectangular, there is no particular limitation regarding their shape. However, it is preferable for them to be similar in shape in the first mode. It was stated that the whole edges of the top layer and the bottom layer were to be joined in a continuous adhesive line in the first mode, a plurality of positions on the edges of the top layer and the bottom layer may as well be subjected to point adhesion, or only one side each of the whole edges of the top layer and the bottom layer may be joined.

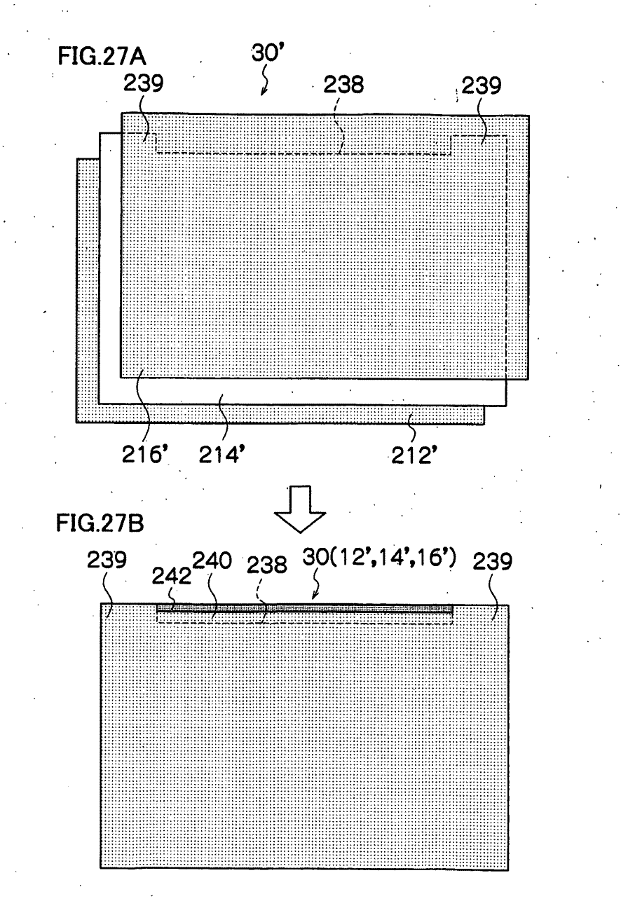

FIGS. 27A and 27B illustrate a second mode, wherein the punching step is so accomplished as to form the respective sheets 12′, 14′ and 16′ of the top layer, the bottom layer and the intermediate layer in rectangular shapes of the same planar size, and form a notch 238 in at least one position on the edge of the prism sheet 14′ of the intermediate layer. At the joining step, only the top layer and bottom layer diffusion sheets 12′ and 16′ are joined via this notch 238.

In this second mode, too, the optical sheet for display use which is the laminated sheet composition 30 is integrated in the form of holding the prism sheet 14′ of the intermediate layer between the top layer and bottom layer diffusion sheets 16′ and 12′. Therefore, as the prism sheet 14′ of the intermediate layer is only held between but not joined to the top layer and bottom layer diffusion sheets 16′ and 12′, bending (such as distortion or curling) of the laminated sheet composition 30 will hardly occur even if there is any difference in thermal expansion or contraction among the plurality of sheets 12′, 14′ and 16′. Further by forming the notch 238 in at least one position on the edge of the prism sheet 14′ of the intermediate layer, a gap 240 of a shape matching the notch 238 is formed between the top layer and bottom layer diffusion sheets 12′ and 16′ and molten matter 242 generated in the joining process is accommodated in this gap 240, making it even more difficult for the molten matter 242 to bulge out of the laminated sheet composition. Incidentally, as the prism sheet 14′ of the intermediate layer is internally contained in the first mode, the prism sheet 14′ will not come off the laminated sheet composition 30 when the composition is handled or on any other occasion. However, as shown in FIGS. 27A and 27B, where joining is accomplished with only one side of the prism sheet 14′ of the intermediate layer via the notch 238 and there is a risk that part of the prism sheet 14′ may leap out of or come off the laminated sheet composition 30 when the composition is handled or on any other occasion, it is preferable to join the prism sheet 14′ of the intermediate layer to part of the top layer and/or the bottom layer diffusion sheets 12′ and 16′. In this case, obviously, it is necessary to join the edge which will not obstruct the screen portion of the liquid crystal display element, advisably to join convexes 239 and 239 on two sides of the notch 238. Incidentally in the first mode as well, the prism sheet 14′ of the intermediate layer may be joined to part of the top layer and/or the bottom layer diffusion sheets 12′ and 16′. Although formation of the notch 238 on one side of the prism sheet 14′ of the intermediate layer is illustrated in FIGS. 27A and 27B showing the second mode, notches may as well be formed in a plurality of sides.

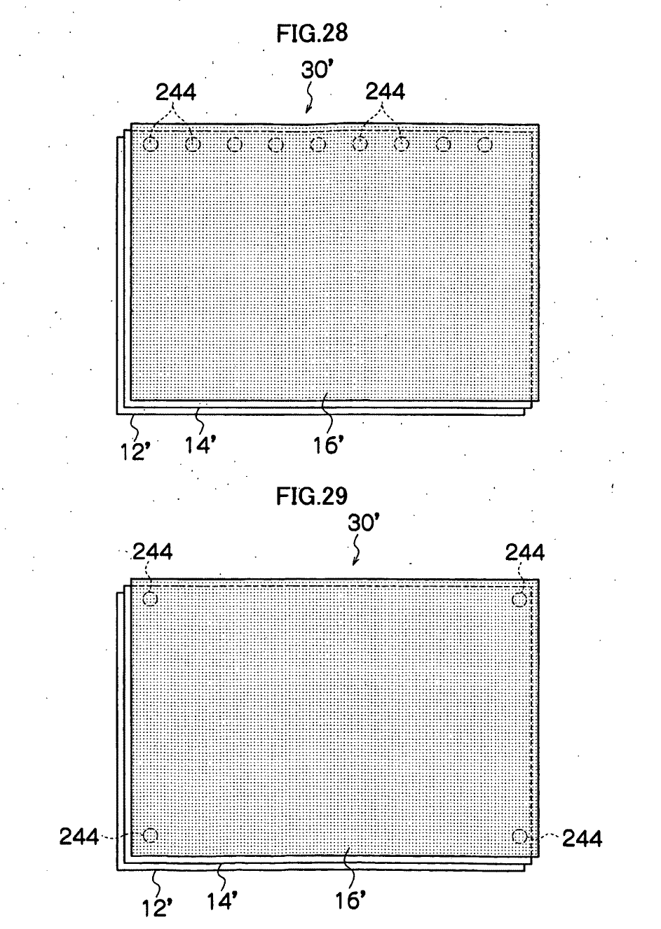

FIG. 28 shows a third mode, wherein the punching step is so accomplished as to form the respective sheets 12′, 14′ and 16′ of the top layer, the bottom layer and the intermediate layer in rectangular shapes of the same planar size, a hole 244 is formed in at least one position on the edge of the prism sheet 14′ of the intermediate layer, and only the top layer and bottom layer diffusion sheets 12′ and 16′ are joined via this hole 244. In this case, molten matter from the top layer diffusion sheet 16′ and molten matter from the bottom layer diffusion sheet 12′ are linked in the position of the hole 244. For this reason, it is preferable to use impulse sealer whose heating section is acicularly shaped as a joining device 225 and to accomplish joining by instantaneous welding. The preferable size of the hole 244 is such that the hole is not completely filled with the molten matter.

In this third mode as well, the optical sheet for display use which is the laminated sheet composition 30 is integrated in the form of holding the prism sheet 14′ of the intermediate layer between the top layer and bottom layer diffusion sheets 12′ and 16′. Therefore, as the prism sheet 14′ of the intermediate layer is only held between but not joined to the top layer and bottom layer diffusion sheets 16′ and 12′, bending (such as distortion or curling) of the laminated sheet composition 30 will hardly occur even if there is any difference in thermal expansion or contraction among the plurality of sheets 12′, 14′ and 16′. Further, as molten matter from the top layer diffusion sheet 16′ and molten matter from the bottom layer diffusion sheet 12′ are accommodated into the hole 244 and linked in the position of the hole 244, there arises a state in which a rod of molten matter penetrates the hole 244. For this reason by boring the holes 244 in two positions, it is possible to eliminate the risk that part of the prism sheet 14′ leaps out of or comes off the laminated sheet composition 30.

FIG. 29 shows a fourth mode, wherein a total of four holes 244 are formed in the four corners of the prism sheet 14′ of the intermediate layer, and only the top layer and bottom layer diffusion sheets 16′ and 12′ are joined via the four holes 244.

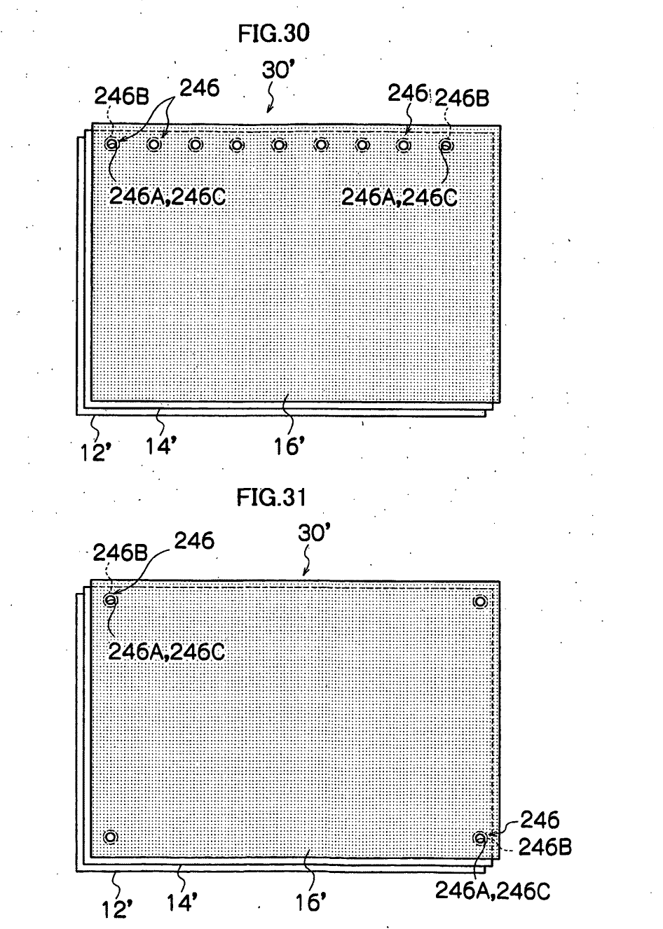

A fifth mode shown in FIG. 30 and a sixth mode shown in FIG. 31 are variations of the third mode of FIG. 28 and the fourth mode of FIG. 29, respectively. Thus at the punching step, the sheets of the top layer, the bottom layer and the intermediate layer are punched into a rectangular shape of the same planar size, and through holes 246 (246A, 246B and 246C) are formed in at least one position each of the edges of the top layer, the bottom layer, the intermediate layer. FIG. 30 shows a case in which nine through holes 246 are formed in one side part of the laminated sheet composition 30. At the joining step, only the top layer and bottom layer diffusion sheets 16′ and 12′ are joined via the holes 24613 in the prism sheet 14′ of the intermediate layer by inserting the joining device 225 into the through holes 246 and melting the surroundings of the holes 246A in the top layer diffusion sheet 16′ and of the holes 246C in the bottom layer diffusion sheet 12′. The joining device to be used in this case should preferably be an impulse sealer whose heating part is acicularly shaped. The holes 246B to be formed in the prism sheet 14′ of the intermediate layer should be larger than the holes 246A and 246C to be formed in the top layer and bottom layer diffusion sheets 16′ and 12′ and also larger than the diameter of the acicular members.

The fifth mode and the sixth mode can also provide similar effects to those of the third mode and the fourth mode.

Next, a joining device 225 other than an impulse sealer will be described.

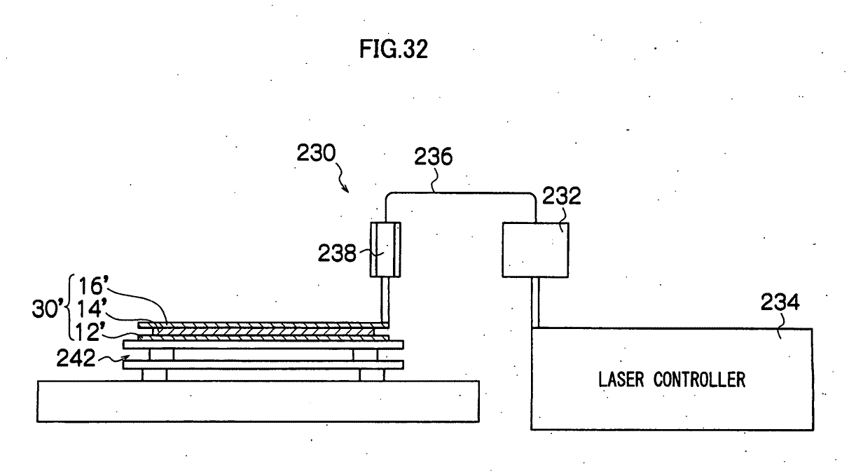

As the laser irradiating device, a YAG laser irradiating device of 355 to 1064 nm in wavelength, a semiconductor laser irradiating device of about 800 nm in wavelength, a carbon dioxide gas laser irradiating device of 9 to 11 μm in wavelength or the like can be used. The oscillation system may be either continuous or pulse oscillation. FIG. 32 shows one example of configuration of a semiconductor laser irradiating device 230. As shown in FIG. 32, the semiconductor laser irradiating device 230 is mainly configured of a semiconductor laser oscillator 232, a laser controller 234 which controls the semiconductor laser oscillator 232, a laser head 238 connected to the semiconductor laser oscillator 232 via an optical fiber 236, and an X-Y table 242 on which the laminated sheet composition 30′ is to be mounted. The laser head 238 is provided with a light condenser (not shown), and the laser beam guided by the optical fiber 236 is condensed by the light condenser in the laser head 238 and irradiates the laminated sheet composition 30′. For instance, a semiconductor laser oscillator 232 of 808 nm in oscillation wavelength was used at an output of 22 W, a laser beam diameter of 0.6 mm and a scanning speed of 112 mm/s as the conditions of laser irradiation for the first mode described above, and the edges of the top layer and bottom layer diffusion sheets 12′ and 16′ were joined with each other. The result endorsed the possibility of joining them with no problem in appearance, joining strength or optical characteristics.

Incidentally, a known mechanism for sucking the smoke arising at the time of joining with laser (suction device or the like) can be provided as well.

When an adhesive is to be used as the joining device 225, it should preferably be an adhesive whose adhesion can be assisted by heat or a catalyst. Specifically, such a common adhesive as silicon adhesive, polyurethane adhesive, polyester adhesive, epoxy adhesive, cyanoacrylate adhesive or acryl adhesive can be used.

As any of the optical sheets for display use 10 through 60 may be used at high temperature, it is preferable for the adhesive to be stable in a range of normal temperature to 120° C. Out of the adhesives cited above, the epoxy adhesive can be suitably used because of its high strength and heat resistance. The cyanoacrylate adhesive can be utilized for efficient fabrication of optical sheets for display use by virtue of its immediate effectiveness and high strength. The polyester adhesive is particularly suitable on account of its high strength and processing ease.

Whereas the adhesives are broadly classified into thermosetting, hot melt and two-part mixing type by the method of adhesion, the thermosetting and hot melt types which permit continuous production are preferable. The preferable application thickness of any of the adhesives is 0.5 μm to 50 μm.

It is further preferable to provide a drying device for drying the adhesive. There is no particular limitation to this drying device, but the drying can be accomplished by any known method, such as drying with warm or hot wind, or drying with dehumidified wind.

Where a double-sided adhesive tape is to be used as the joining device 225, highly sticky acryl copolymer resin can be used as the adhesive of the double-sided tape. Other usable ones include silicon, natural rubber and synthetic rubber adhesives, but an acryl adhesive is preferable on the basis of overall evaluation of physical strengths including heat resistance and anti-creep property and the price.

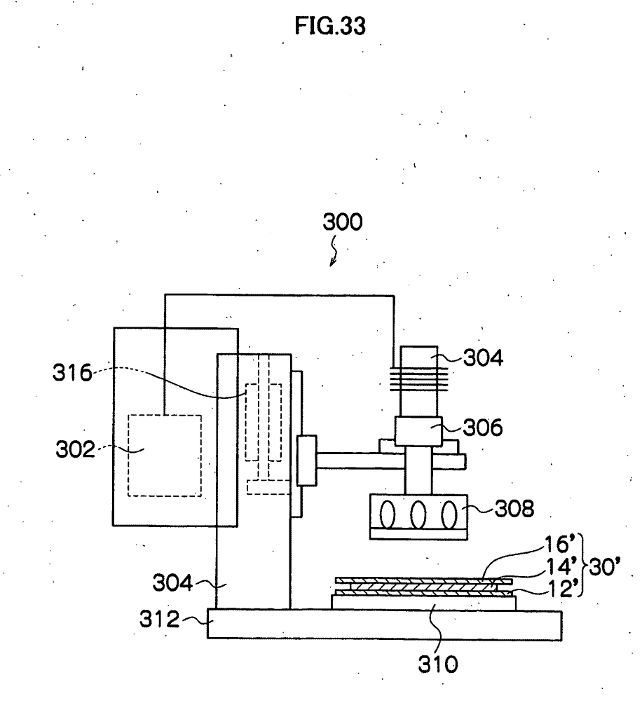

FIG. 33 shows one example of ultrasonic welding device 300, which is mainly provided with an oscillator 302, a resonator 304, a booster 306, an ultrasonic horn 308 and a receptacle table 310. An air cylinder 316 is built into a press strut 314 stood on a stool 312. The ultrasonic horn 308 is shifted by this air cylinder 316 in the up-and-down directions. When the ultrasonic horn 308 of this configuration was used for joining in the first mode at an output of 1 kW and a pressurizing force of 34 kg, the result endorsed the possibility of joining with no problem in appearance, joining strength or optical characteristics.

### Fourth Embodiment for Carrying Out the Invention

A fourth embodiment for carrying out the invention will be described below with reference to accompanying drawings. Incidentally, the configuration of the optical sheet for display use of the laminated sheet composition type (first through sixth examples) is the same as that in the first embodiment described with reference to FIG. 1 through FIG. 6, and will be described by using the same corresponding signs.

A manufacturing apparatus 400 for implementing the manufacturing method for optical sheets for display use according to the invention will be described. Although this manufacturing apparatus 400 is applicable commonly to all the optical sheets for display use 10 through 60 already described, for the sake of convenience of explanation the following description will refer to a case in which the method is applied to a four-layered optical sheet for display use (first example).

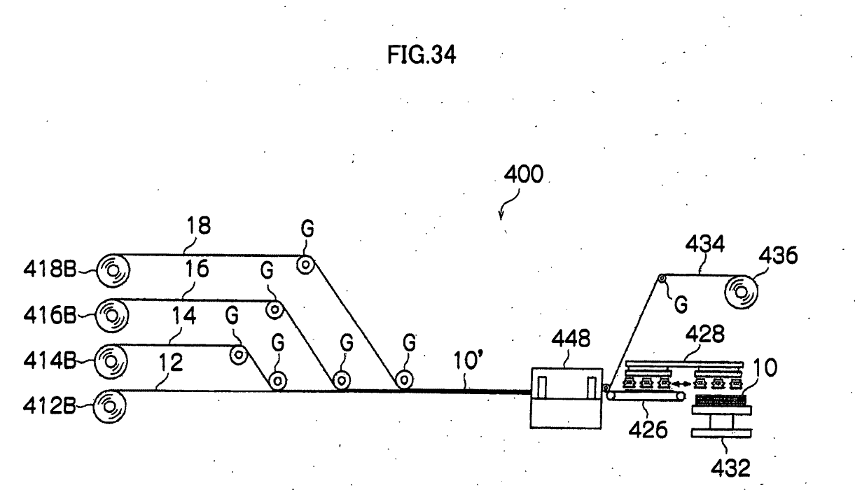

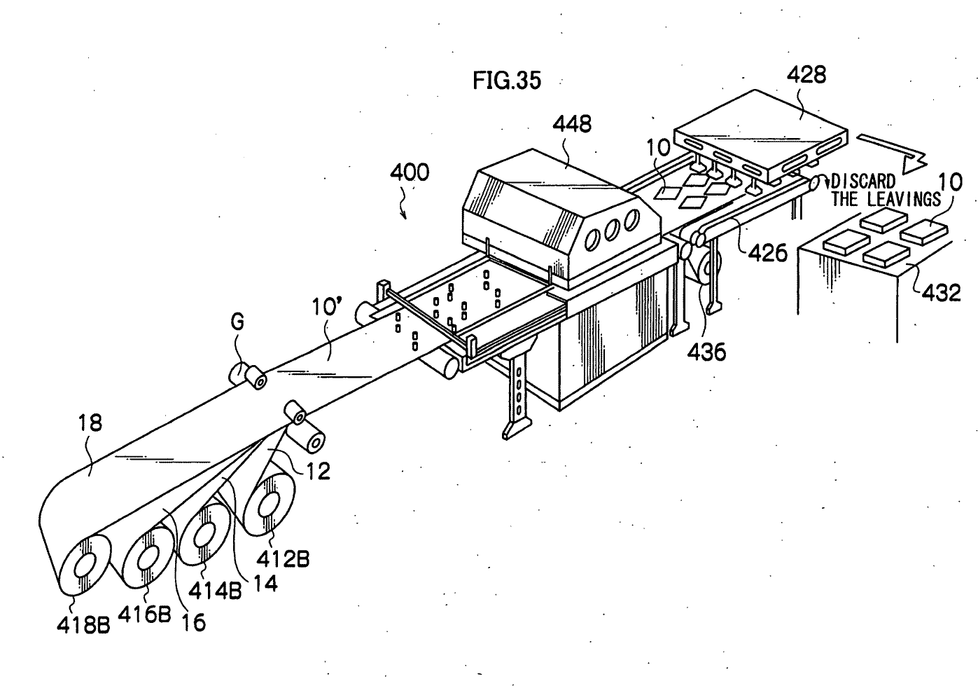

FIG. 34 is a conceptual diagram showing the overall configuration of the manufacturing apparatus for optical sheets for display use, and FIG. 35 shows a perspective view.

As shown in FIG. 34 and FIG. 35, rollers 412B, 414B, 416B and 418B disposed toward the left ends of the drawings are rollers around which the belt-shaped first diffusion sheet 12, first prism sheet 14, second prism sheet 16 and second diffusion sheet 18 described above with reference to FIG. 1 are respectively wound.

The rollers 412B, 414B, 416B and 418B are pivoted on the rotation shafts of feeding devices (not shown), and the belt-shaped first diffusion sheet 12, first prism sheet 14, second prism sheet 16 and second diffusion sheet 18 can be fed out of the rollers 412B, 414B, 416B and 418B, respectively, at substantially equal speeds.

The belt-shaped first diffusion sheet 12, first prism sheet 14, second prism sheet 16 and second diffusion sheet 18 which have been fed out are supported respectively by guide rollers G, G . . . , and eventually stacked one over another on the upstream side of the punching press 448 to be described afterwards. A belt-shaped laminated sheet composition is thereby formed (stacking step). Hereinafter, the belt-shaped laminated sheet composition before being punched by the punching press 448 will be referred to as the uncut laminated sheet composition 10′, and what has been punched into the product size, as simply the laminated sheet composition 10.

Next, the uncut laminated sheet composition 10′ is punched by the punching press 448 equipped with a punching blade for external shaping (not shown), to be described in detail afterwards, and a punching blade for joining use 420 to be formed into a plurality of laminated sheet compositions 10, and at the same time one or more positions of the edges of the laminated sheet compositions 10 are joined. On the other hand, a sheet residual 434 remaining after the punching, guided by the guide roller G, is taken up around a take-up roller 436 of a take-up device (details not shown). Next, the punching press 448 will be described.

The punching press 448 is a device which cuts the uncut laminated sheet composition 10′ into laminated sheet compositions 10 of the product size and at the same time joins them. This punching press 448 is provided with a punching blade for joining use 420 which joins one or more positions of the edges of the laminated sheet compositions 10 in the product size in addition to the punching blade for external shaping to be used for punching into the product size. The punching blade for external shaping, though not described in particular, is similar to the blade of any known punching press.

As shown in FIG. 36, notches 421 are cut in the punching blade for joining use 420 having a U-shaped section to enable the uncut laminated sheet composition 10′ to be punched leaving a linking part 427 (see FIG. 39). Thus, the notch 421 part constitutes the linking part 427 after punching. Incidentally, the punching blade for joining use 420 is shown to have a U-shaped section in FIG. 36, it may have any other shape only if the shape allows punching with the linking part 427 left, such as a C-shaped, cylindrical, rectangular or triangular shape.

Furthermore, a pressing bar 419 is disposed within the punching blade for joining use 420 having a U-shaped section. This pressing bar 419 is provided to give a folding pattern to the linking part 427 by punching the uncut laminated sheet composition 10′ with the punching blade for joining use 420 leaving the linking part 427 and pressing this linking part 427, and thereby to join the laminated sheet composition 10 with a sufficient joining force to prevent it from being broken by an external force of a strength which would result from handling. Therefore, no blade is formed at the tip of this pressing bar 419.

It is preferable for the tip of this pressing bar 419 to be flush as the tip of the punching blade for joining use 420. Even if the tip of the pressing bar 419 is somewhat recessed or protruded relative to the tip of the punching blade for joining use 420, the effect of folding the punched part under pressure can be achieved, but keeping them at the same level ensures achievement of the effect of folding the punched part under pressure.

The punching press 448 is equipped with a plurality of sets each of the punching blade for external shaping and the punching blade for joining use 420. The number of the punching blade for joining use 420 in one set of punching blades need not be one, but is as many as the number of joints, and the plurality of the blades are so disposed as to match the positions where the edges of the laminated sheet composition 10 of the product size are joined (e.g. the four corners of the laminated sheet composition). Further, a mounting base 422 to be mounted with the uncut laminated sheet composition 10′ should be of such a material as would permit, when the uncut laminated sheet composition 10′ is punched with the punching blade for joining use 420, the punching blade for joining use 420 to cut into it.

Further, the punching blade for joining use 420 may be provided with a pressing device which, when drawing out the punching blade for joining use 420 after having punched the uncut laminated sheet composition 10′, can press the vicinities of the punched position of the uncut laminated sheet composition 10′. However, for the sake of convenience of description, this pressing device will be described in connection with another embodiment (the punching press 448′).

Since the punching press 448 is configured as described above, a plurality of laminated sheet compositions 10 of the product size can be foamed and at the same time at least one position of the edge of each laminated sheet composition 10 of the product size can be joined by punching the uncut laminated sheet composition 10′. Incidentally, though the description of this embodiment supposes providing the punching press 448 with both the punching blade for external shaping and the punching blade for joining use 420, each of the punching blade for external shaping and the punching blade for joining use 420 may be disposed on a separate punching press.

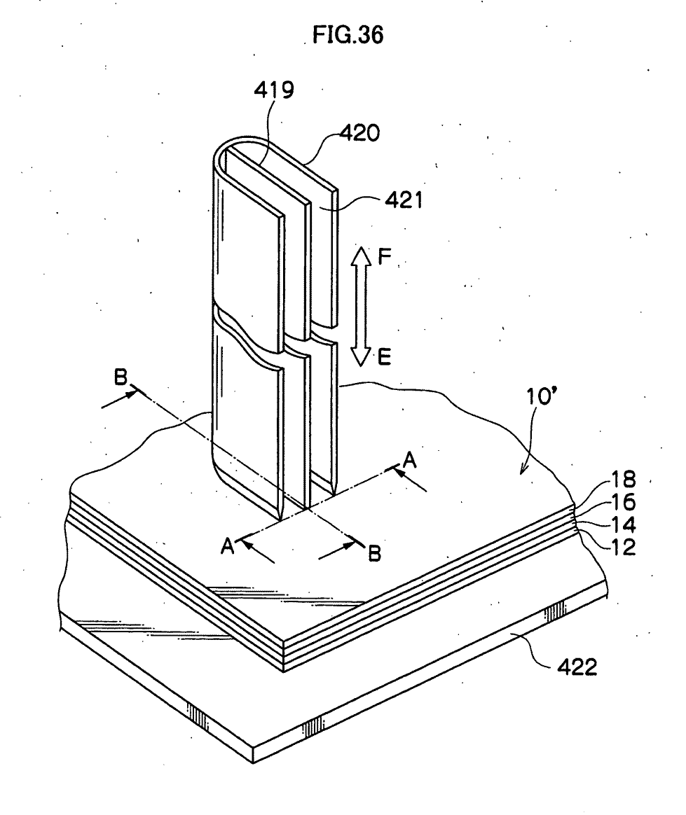

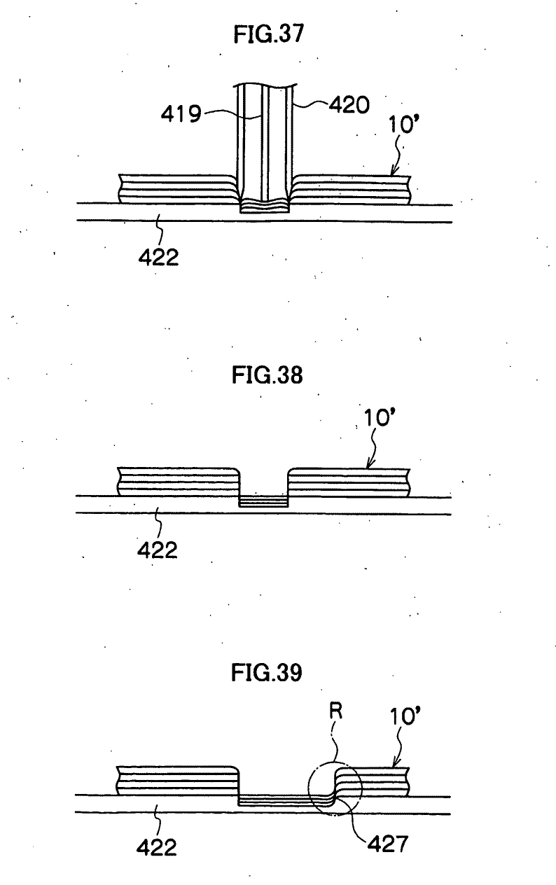

Next, the mechanism of joining the laminated sheet composition 10 by the punching press 448 using the punching blade for joining use 420 and the pressing bar 419 will be described with reference to FIG. 37 through FIG. 39. Incidentally, FIG. 37 and FIG. 38 are arrowed diagrams along line A-A in FIG. 36, and FIG. 39, an arrowed diagram along line B-B in FIG. 36.

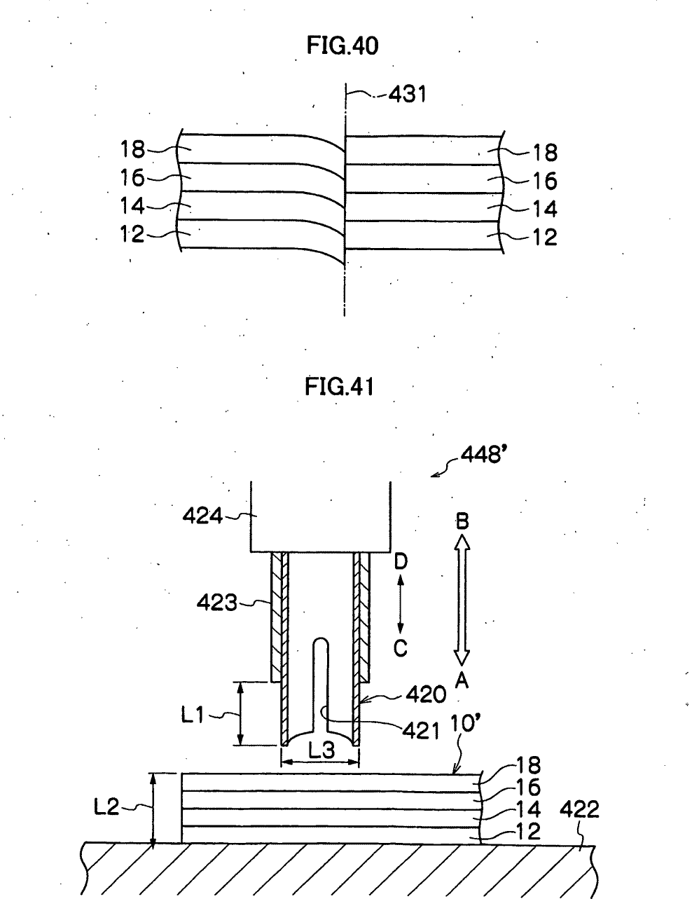

As shown in FIG. 37, the punching blade for joining use 420 is moved downward in the direction of arrow E in FIG. 36 to punch the uncut laminated sheet composition 10′ leaving the linking part 427 as shown in FIG. 39. A microscopically enlarged view of the punched section of the uncut laminated sheet composition 10′ leaving the linking part 427 in this way reveals, as shown in FIG. 40, the formation of a fault structure by the optical sheets on both sides of a punching line 431 as the boundary. This fault structure causes the optical sheets on both sides of the punching line 431 to engage with each other spanning different layers.

FIG. 38 and FIG. 39 already referred to show the shape after the punching of the uncut laminated sheet composition 10′ leaving the linking part 427. The arrangement of the pressing bar 419 within the punching blade for joining use 420 as in this the punching press 448 enables the folding pattern to be formed in the linking part 427 as shown within the circle R in FIG. 39 even after the punching blade for joining use 420 has withdrawn and this shape to be maintained. This makes the state of engagement of the optical sheets with each other even firmer.

Incidentally, the edge angle θ of the punching blade for joining use 420 and the planar arrangement of the punching blade for joining use 420 in the punching press 448 will be described in connection with another embodiment (the punching press 448′).

Next, the punching press 448′ in other embodiment will be described.

Incidentally, members which are the same as or similar to their counterparts in FIG. 36 and elsewhere will be designated by respectively the same reference signs, and their detailed description will be omitted. This punching press 448′ is not provided with the pressing bar 419.

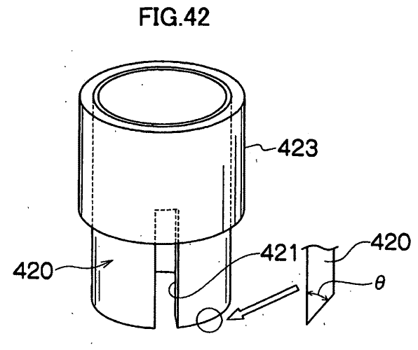

As shown in FIG. 41 and FIG. 42, the notch 421 is cut in the cylindrical punching blade for joining use 420 to enable the uncut laminated sheet composition 10′ to be punched leaving the linking part 427 (see FIG. 39). Thus, the notch 421 part constitutes the linking part 427 after punching. Incidentally, the punching blade for joining use 420 is shown to have a cylindrical shape in FIG. 41, there is no particular limitation to its shape if its shape allows punching with the linking part 427 left as described already. It is generally preferable for the diameter L3 of the punching blade for joining use 420 when it is cylindrically shaped to be 1 mm to 20 mm though it more or less varies with the shape of the cylinder.

The punching blade for joining use 420 is provided with a pressing device 423 which presses the vicinities of the punched position of the uncut laminated sheet composition 10′ when drawing out the punching blade for joining use 420 after the uncut laminated sheet composition 10′ is punched. As this pressing device 423, a sponge member which is wound around the upper external circumference of the punching blade for joining use 420 and whose upper end is fixed to a supporting member 424 as shown in FIG. 41 and FIG. 42, for instance, can be suitably used. This arrangement enables the sponge member to expand and contract with the punching blade for joining use 420 as its axial core.

The distance L1 from the tip of the punching blade for joining use 420 to the sponge member is formed to be shorter than the total L2 of the thickness of the uncut laminated sheet composition 10′ and the distance at which the punching blade for joining use 420 cuts into the mounting base 422. This enables, when the uncut laminated sheet composition 10′ is punched, the tip of the sponge member to come into contact with the upper face of the uncut laminated sheet composition 10′ and contract and the resultant reactive force to press the vicinities of the punched position.

While a spring or the like can be used as the pressing device 423, its springy force should not be too strong, but barely sufficient to prevent the state in which the uncut laminated sheet composition 10′ has been punched by the punching blade for joining use 420 from returning to the prior state.

Since the punching press 448′ is configured as described above, a plurality of laminated sheet compositions 10 of the product size can be formed by punching the uncut laminated sheet composition 10′ and at least one position on the edge of each laminated sheet composition 10 of the product size can be joined.

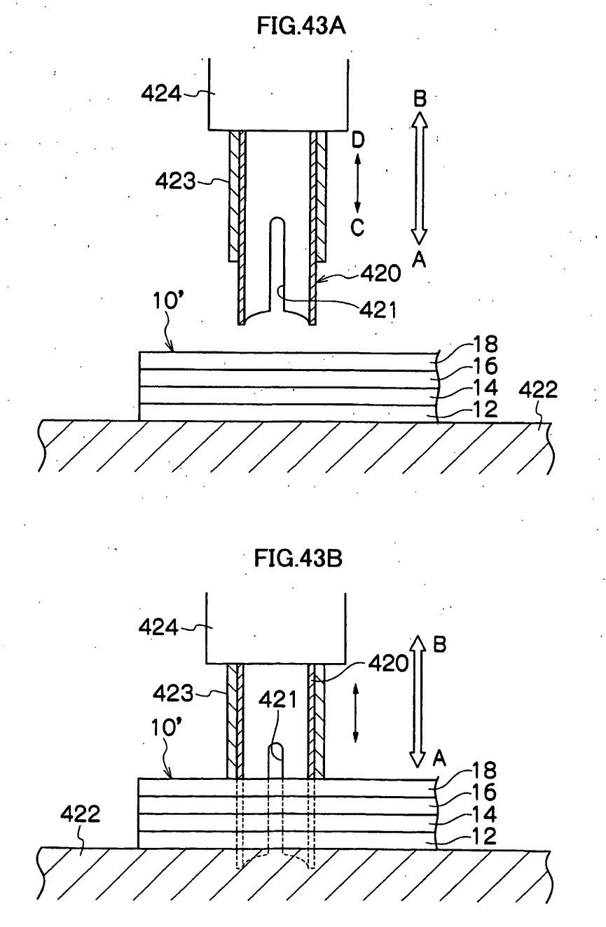

Next, the mechanism for joining the laminated sheet composition 10 by the punching blade for joining use 420 will be described with reference to FIGS. 43A, 43B and 43C. As shown in FIG. 43A, the punching blade for joining use 420 is moved downward in the direction of arrow A to punch the uncut laminated sheet composition 10′ leaving the linking part 427 as shown in FIGS. 43A and 43B.

A microscopically enlarged view of the punched section of the uncut laminated sheet composition 10′ leaving the linking part 427 in this way reveals, as shown in FIG. 40 already referred to, the formation of a fault structure by the optical sheets on both sides of a punching line 431 as the boundary. This fault structure causes the optical sheets on both sides of the punching line 431 to engage with each other spanning different layers.

Also, when drawing out the punching blade for joining use 420, the presence of the pressing device 423 enables the punching blade for joining use 420 can to be drawn with the fault structure maintained. This enables the laminated sheet composition 10 to be joined with a sufficient joining force to prevent it from being broken by an external force of a strength which would result from handling.

In this case, it is preferable for the edge angle θ of the punching blade for joining use 420 to be not smaller than 43° as shown in FIG. 42. This is because the blade will be too sharp to make the fault structure to be formed if the edge angle θ is less than 43°.

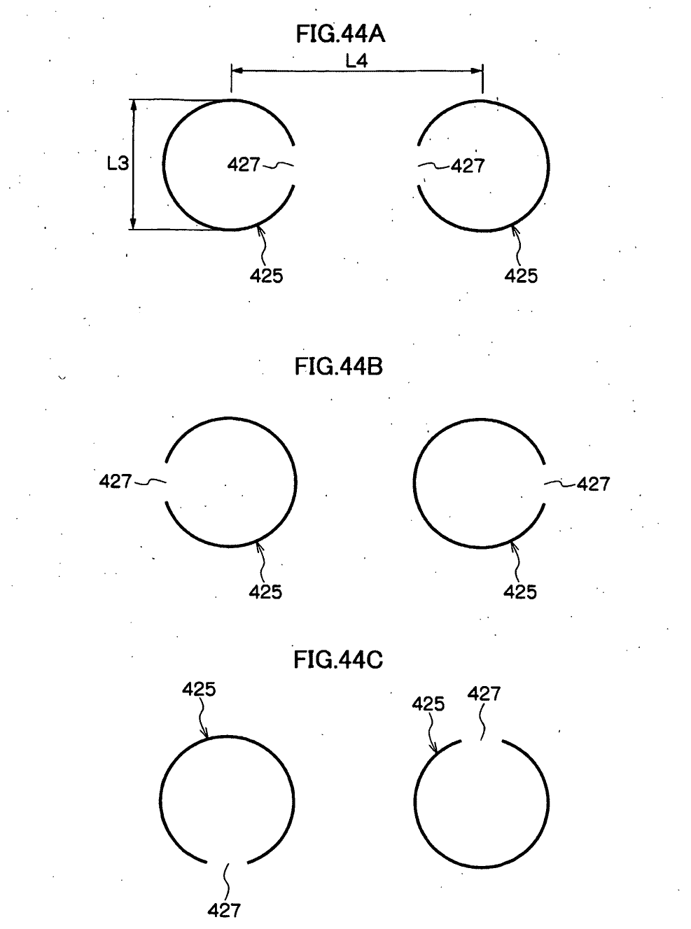

Further, it is preferable for a pair of punched shapes to be formed opposite each other in close positions as shown in FIGS. 44A through 44C. Formation of a pair of punched shapes opposite each other in close positions can make the joining force stronger than when a pair of punched shapes 425 are formed at random. Though the reason for this stronger force is not certain, presumably the formation of a pair of punched shapes 425 opposite each other in close positions causes a complex force (e.g. a mutually pulling or pushing force) to work on the punched section referred to above.

In this case, it is preferable for the close distance L4 to be not more than 20 mm, because a greater distance than 20 mm between the paired punched shapes 425 would weaken the joining force. Incidentally, the number of the linking part 427 is not necessarily limited to one, but forming a large number of linking parts 427 would make it difficult for the fault structure to be formed.

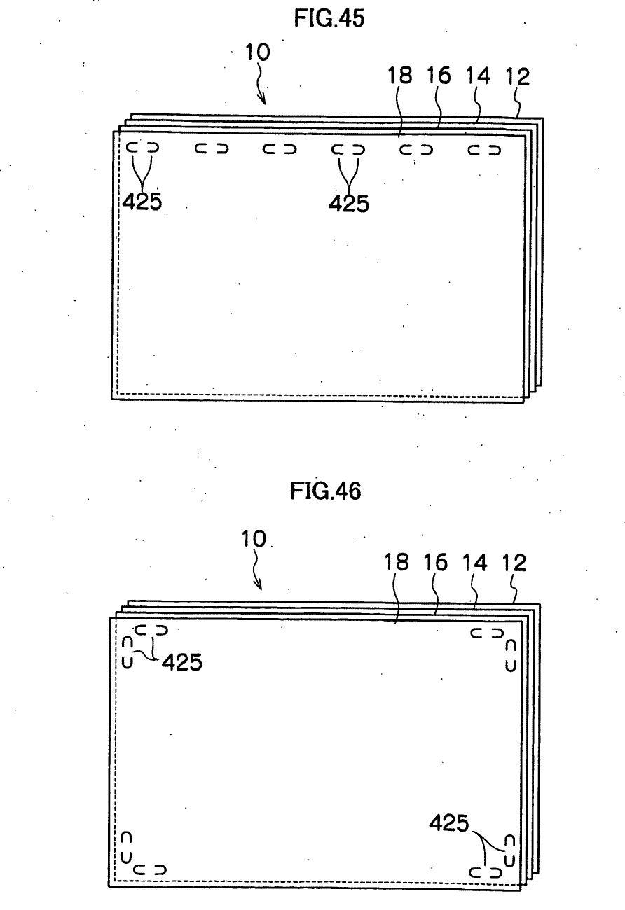

Although there is no particular limitation to the joining positions or the number of joints of the laminated sheet composition 10 if only they are on the peripheral part, a plurality of joints may be made on one side of the peripheral part of the laminated sheet composition as shown in FIG. 45 or the laminated sheet composition may be joined at the four corners of the periphery as shown in FIG. 46.

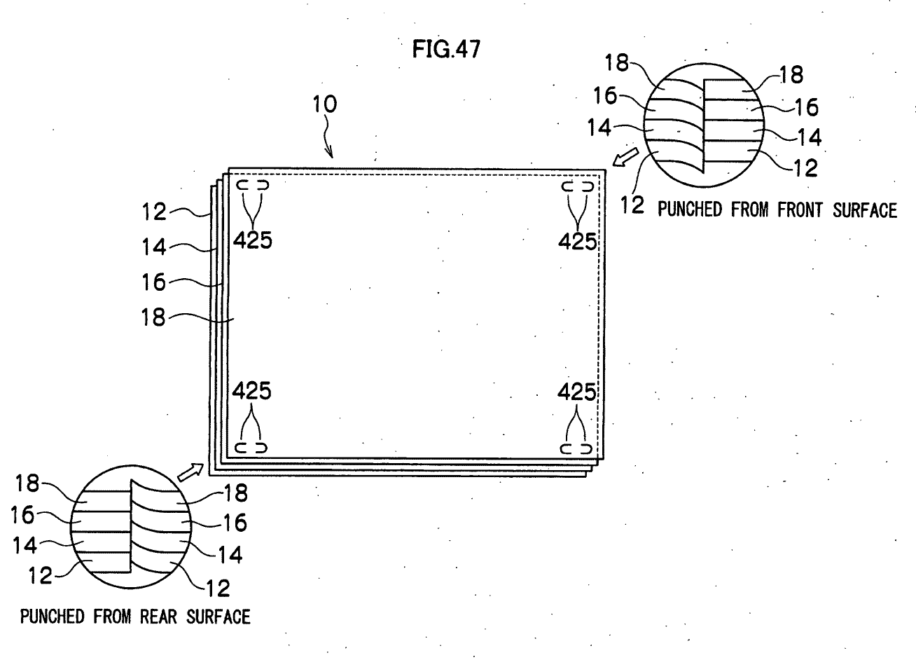

Nor is the punching limited to one side of the laminated sheet composition, but there may be both a punched shape 425 formed from one side and another punched shape 425 formed from another side as shown in FIG. 47. The fault structure between the front and rear faces of the laminated sheet composition 10 could contribute to increasing the joining force.

As the laminated sheet composition 10 is joined by punching with the punching blade for joining use 420 in this way according to the invention, molten matter does not deteriorate the dimensional accuracy of the laminated sheet composition 10 as in the case of applying a welding method. Moreover, the joining force is weaker than that of welding or adhesion, the joined laminated sheet composition 10 is immune from bending which would result from a difference in thermal expansion or contraction among a plurality of types of optical sheets.

The method and the apparatus for manufacturing an optical sheet for display use so far described can provide 1) the streak defect reducing effect, 2) assembling man-hour reducing effect and 3) protective sheet reducing effect, but the description of details of these effects is omitted because they are similar to those of the first embodiment. Also, the planar arrangement of sheets (the optical sheets for display use 10) punched out of the laminate of the first diffusion sheet 12, first prism sheet 14, second prism sheet 16 and second diffusion sheet 18 is also similar to that in the first embodiment described with reference to FIGS. 10A and 10B.

According to the invention, as described with reference to the first embodiment, 1) cost reduction and an enhanced product value through reduced thickness and 2) performance improvement through prevention of a drop in light condensing effect can be achieved. Details are similar to those of the first embodiment.

Incidentally, while the invention has been described with reference to examples of optical sheet for display use and the manufacturing method and apparatus therefor, the invention is not limited to the foregoing examples of embodiment, but can be realized in various other embodiments.

For instance, while the uncut laminated sheet composition 10′ remains as punched leaving the linking part 427 in every case of the examples embodiment described above, there can be added a folding-back step at which the punched shape is folded back toward the rear face of the laminated sheet composition 10 with the linking part 427 as the base end. In this way, though the number of steps increases, the fixation between the optical sheets is made even firmer.

Nor is the layered configuration of the optical sheet for display use is limited to the examples of embodiment, but protective sheets can be stacked both over the top and underneath the bottom, for instance. Such a configuration would function similarly and provide similar effects to the foregoing embodiment.

### EXAMPLES

### (1) Examples in the First Embodiment of the Invention

### [Preparation of Prism Sheet]

A prism sheet for use as the first prism sheet 14 and the second prism sheet 16 was prepared. This prism sheet will be used in common as the first prism sheet 14 and the second prism sheet 16.

Adjustment of Resin Liquid

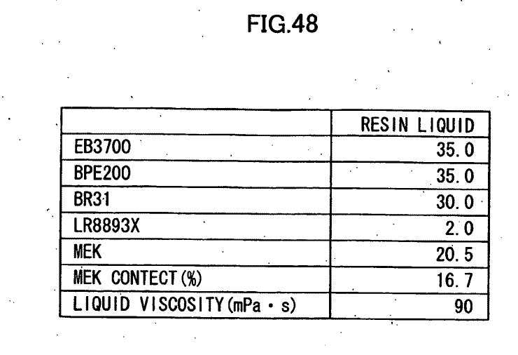

Chemical compounds listed in the table of FIG. 48 were mixed in the weight ratio stated therein, and the mixture was heated to 50° C., stirred and dissolved to obtain a resin liquid. The names and particulars of the compounds are listed below.

EB3700: Ebecryl 3700, product of Daicel UC Co., Ltd. Bisphenol A type epoxy acrylate, (Viscosity: 2200 m Pa·s/65° C.)
BPE200: NK ester BPE-200, product of Shin-Nakamura Co., Ltd. Ethylene oxide-added bisphenol A methacrylate ester, (Viscosity: 590 m Pa·s/25° C.)
BR-31: New Frontier BR-31, product of Dai-ichi Kogyo Seiyaku Co. Ltd.
Tribromophenoxy ethyl acrylate, (Solid at normal temperature, M.P. 50° C. or above)
LR8893X: Lucirin LR8893X, optical radical generating agent manufactured by BASF Japan Ltd. Ethyl-2, 4, 6-trimethylbenzoyl ethoxy phenyl phosphine oxide
MEK: Methyl ethyl ketone

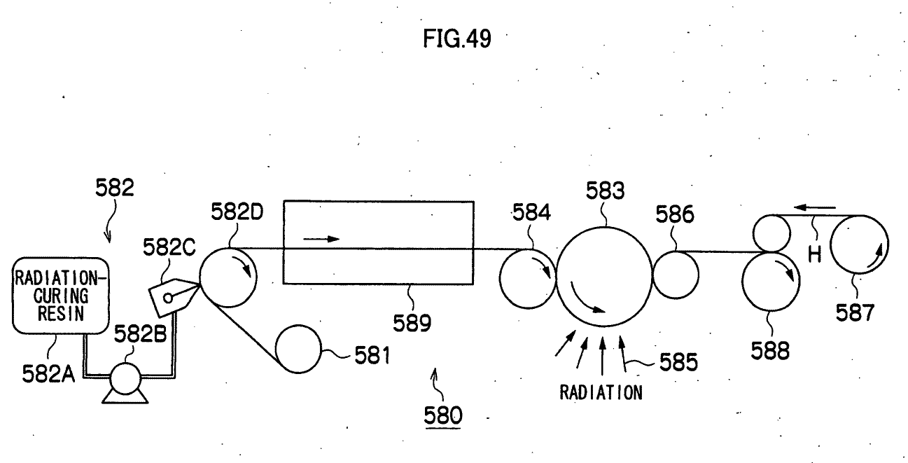

A prism sheet manufacturing apparatus of the configuration shown in FIG. 49 was used to accomplish prism sheet production 580.

As a sheet W, a transparent polyethylene terephthalate (PET) film of 500 mm in width and 100 μm in thickness was used.

As an emboss roller 583, an S45C roller of 700 mm in length (the widthwise direction of the sheet W) and 300 mm in diameter having a nickel surface was used. Grooves of a 50 μm pitch were formed fully around the surface of the roller in a width of about 500 mm by cutting with a diamond byte (single-pointed). The sectional shape was triangular, of which the apex angle was 90 degrees and the bottom of the groove was also triangular at 90 degrees with no flat part. Thus, the groove was 50 μm wide and about 25 μm deep. Since the grooves were endless with no seam in the circumferential direction of the roller, a lenticular lens (prism sheet) having a triangular section can be formed on the sheet W with this emboss roller 583. The surface of the roller was plated with nickel after the grooves were cut.

As a liquid applying device 582, a die coater having an extrusion type applying head 582C was used.

The applied liquid F (resin liquids) used had a composition stated in the table of FIG. 48 referred to above. The supply quantity of the applied liquid F to the applying head 582C was so controlled with a supply device 582B as to make the film thickness of the applied liquid F (resin) in a wet state after the drying of organic solvent 20 μm.

As a drying device 589, a circulating type hot air drying device was used. The temperature of the hot air was 100° C.

As a nip roller 584, a roller of 200 mm in diameter having a silicon rubber layer of 90 in rubber hardness was formed on the surface was used. The nip pressure at which the sheet W was pressed with the emboss roller 583 and the nip roller 584 (effective nip pressure) was 0.5 Pa.

As a resin hardening device 585, a metal halide lamp was used, and the resin was irradiated with energy of 1000 mJ/cm².

This procedure provided a prism sheet on which a convex-concave pattern was formed.

### [Preparation of First Diffusion Sheet 12]

The first diffusion sheet 12 (diffusion sheet for lower use) was prepared by fabricating the undercoat layer, back coat layer and light diffusion layer in that sequence by the following methods.

Undercoat Layer

Liquid A as the liquid applied for the undercoat layer of the following composition was applied to one face of a polyethylene terephthalate film (support) of 100 μm in thickness with a wire bar (#10 in wire size), and after drying for two minutes at 120° C. an undercoat layer of 1.5 μm in film thickness was obtained.

(Liquid Applied for Undercoat Layer)

| | |
|---|---|
| Methanol | 4165 g |
| Julymer SP-50T (product of Nihonjunyaku Co., Ltd.) | 1495 g |
| Cyclohexanone | 339 g |
| Julymer MB-1X (product of Nihonjunyaku Co., Ltd.) | 1.85 g |

(Organic particles: Spherical ultra-fine particulates of cross linking type polymethyl methacrylate, 6.2 μm in the diameter of average weight particle)

Back Coat Layer

Liquid B as the liquid applied for the back coat layer of the following composition was applied to the reverse face to the undercoated face of the support was applied with a wire bar (#10 in wire size), and after drying for two minutes at 120° C. a back coat layer of 2.0 μm in thickness was obtained.

(Liquid Applied for Back Coat Layer)

| | |
|---|---|
| Methanol | 4171 g |
| Julymer SP-65T (product of Nihonjunyaku Co., Ltd.) | 1487 g |
| Cyclohexanone | 340 g |
| Julymer MB-1X (product of Nihonjunyaku Co., Ltd.) | 2.68 g |

(Organic particles: Spherical ultra-fine particulates of cross linking type polymethyl methacrylate, 6.2 μm in the diameter of average weight particle)

Light Diffusion Layer

Liquid C as the liquid applied for the light diffusion layer of the following composition was applied to the undercoated face of the support prepared as described above with a wire bar (#22 in wire size), and after drying for two minutes at 120° C., the light diffusion layer was obtained. As will be described in further detail afterwards, two versions of this light diffusion layer were obtained, one applied immediately after the preparation of liquid C and the other which had been allowed to stand still for two after the adjustment of liquid C.

(Liquid Applied for Light Diffusion Layer)

| | |
|---|---|
| Cyclohexanone | 20.84 g |
| Disparlon PFA-230, 20 mass % in solid content concentration | 0.74 g |
| (Particle precipitation preventing agent: Fatty acid amide, | |
| product of Kusumoto Chemicals, Ltd.) | |
| Acryl resin (Dianal BR-117, product of Mitsubishi Rayon | 17.85 g |
| Co., Ltd.) 20 mass % of methyl ether ketone solution | |
| Julymer MB-20X (product of Nihonjunyaku Co., Ltd.) | 11.29 g |
| (Organic particles: Spherical ultra-fine particulates of | |
| cross linking type polymethyl methacrylate, 18 μm in | |
| the diameter of average weight particle) | |
| F780F (product of Dainippon Ink and Chemicals, Incorporated) | 0.03 g |
| (30 mass % of methyl ether ketone solution) | |

### [Preparation of Second Diffusion Sheet 18]

The second diffusion sheet 18 (diffusion sheet for upper use) was prepared under the same conditions and in the same flow as the first diffusion sheet 12 except that the quantity of Julymer MB-20X added to the light diffusion layer of the first diffusion sheet 12 was changed from 11.29 g to 1.13 g.

### [Method of Preparing Optical Sheet for Display Use]

The configuration of the optical sheet for display use, as shown in FIG. 3 referred to above, was that of the optical sheet for display use 30 (optical sheet module) comprising in an ascending order the first diffusion sheet 12, the first prism sheet 14 and the second diffusion sheet 18. The joint 30A was in the form shown in FIGS. 7A and 7B (one long side).

As the thermoadhesive film 80, a thermoadhesive film manufactured by Nihon Matai Co., Ltd. (product name: Elphan PHE411 (polyester)) was used.

The thermoadhesive films 80 of 1 mm, 2 mm, 3 mm, 4 mm and 5 mm in width (width W in FIGS. 7A and 7B W) were made ready. The thicknesses of the thermoadhesive films 80 of different widths were respectively 0.05 mm (0.02 mm after adhesion), 0.1 mm (0.05 mm after adhesion), 0.2 mm (0.1 mm after adhesion) and 0.3 mm (0.15 mm after adhesion).

The temperature of the sealing part of the impulse sealer 72 was set to 150° C., and the pressure was set to 0.2 MPa (2 kgf/cm²).

### [Evaluation of Optical Sheet for Display Use]

The optical sheet for display use that was prepared was incorporated into a commercially available liquid crystal device (back light unit), and the state of adhesion and the presence or absence of interference fringes were evaluated.

For the evaluation of the state of adhesion, when only the second diffusion sheet 18 of the top face was lifted, if the joint 30A between sheets was not removed, the state was judged good and, if the joint 30A came off if only partly, the state was judged poor.

For the evaluation of the presence or absence of interference fringes, a composition which results in no interference fringes attributable to the thermoadhesive film was judged good, and one in which any interference fringes attributable to the thermoadhesive film were observed was judged poor.

As an overall evaluation, what was good in both the state of adhesion and the presence or absence of interference fringes was judged acceptable.

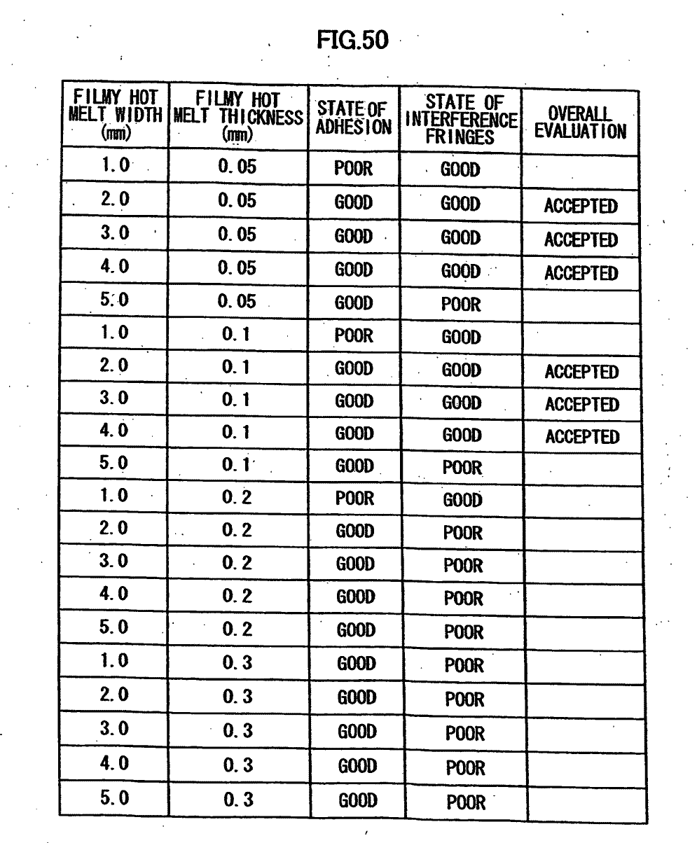

The results of this evaluation are put together in the table of FIG. 50. This table indicates that compositions of which the width of the thermoadhesive film was 2 to 4 mm and the thickness of the same was 0.05 to 1 mm were found good in overall evaluation.

Even those found poor in overall evaluation were confirmed to be no inferior to conventional optical sheets for display use (laminates of optical sheets) and could be used in back light units. Therefore, the various advantages of the present invention were confirmed.

### (2) Example in the Second Embodiment of the Invention

As the prism sheet, the first diffusion sheet 12 and the second diffusion sheet 18 were prepared in the same way as in the example in the first embodiment of the invention, their description is omitted.

Regarding the configuration for the optical sheet for display use, it was the optical sheet for display use 30 (optical sheet module) configured by stacking, in an ascending order, the first diffusion sheet 12, the first prism sheet 14 and the second diffusion sheet 18 as shown in FIG. 3 referred to above. The joint 30A was in the form shown in FIGS. 7A and 7B (one long side). The pitch P of the through holes 180, 180 . . . was 90 mm.

Optical sheets were engaged with each other by using the through hole boring device 152 shown in FIG. 12. The set temperature of the heater block 158 was unified to 280° C. in every case.

The diameter of the tip N1 of the acicular member N was varied in seven stages from 0.2 mm of Level 1 to 2.3 mm of Level 7.

### [Evaluation of Optical Sheet for Display Use]

The diameters of the through holes 180 after the prepared optical sheet for display use was machined were measured with a measuring microscope. Also, the linked state of the prepared optical sheet for display use was evaluated, and the qualitative stated of the machined through holes 180 was evaluated. An overall evaluation was made on the basis of the results of these individual evaluations.

The criteria of evaluation (Good or Poor) and the results of evaluation are put together in the table of FIG. 51.

The results given in this table reveal that the evaluation is good in every respect in the diameter range of the tip N1 of the acicular member N from 0.3 to 2.0 mm. On the other hand, the overall evaluation is poor for that of 0.2 mm in diameter, below the 0.3 mm lower limit and that of 2.3 mm, above the 2.0 mm upper limit.

### (3) Example in the Third Embodiment of the Invention

As the prism sheet 14′, the first diffusion sheet 12′ and the second diffusion sheet 16′ were prepared in the same way as in their respective counterparts in the example in the first embodiment of the invention, the description is omitted.

The following examples were performed by using these sheets.

### Example 1

### First Embodiment

The rectangular prism sheet 14′ of the intermediate layer was so punched as to be shorter by 6 mm in the length of each side than the rectangular top layer and bottom layer diffusion sheets 12′ and 16′, and the sheets were stacked in the descending sequence of the diffusion sheet 16′, the prism sheet 14′ and the diffusion sheet 12′. Only the top layer and bottom layer diffusion sheets 12′ and 16′ were so joined by using the impulse sealer 225 (product of Fuji Impulse Co., Ltd.) as not to obstruct the prism sheet 14′ and let the molten matter 236 come to 3 mm inside from the end of each side of the top layer and the bottom layer. The heating time and cooling time for appropriate welding were about two seconds and five seconds, respectively.

As a result, satisfactory joining was successfully accomplished with no problem in external dimensions, appearance (absence of bending), adhesive strength and optical performance of the optical sheet for display use, which is the laminated sheet composition 30. Nor was observed any bending of the optical sheet for display use over time.

### Example 2

### Second Embodiment

A notch 238 was so cut in one side of the rectangular prism sheet 14′ of the intermediate layer to have a groove depth of 10 mm (10 mm in the convex height on both sides of the notch 238), and the diffusion sheet 16′, the prism sheet 14′ and the diffusion sheet 12′ were stacked in that sequence from above. Only the top layer and bottom layer diffusion sheets 12′ and 16′ were so joined by using the impulse sealer 225 (product of Fuji Impulse Co., Ltd.) as not to obstruct the prism sheet 14′ and let the molten matter 236 come to 3 mm inside from the end of each side of the top layer and the bottom layer which are matching the notch 238. The convex part 239 was subjected to one-point joining with the top layer and bottom layer diffusion sheets 12′ and 16′.

As a result, satisfactory joining was successfully accomplished with no problem in external dimensions, appearance (absence of bending), adhesive strength and optical performance of the optical sheet for display use, which is the laminated sheet composition 30. Nor was observed any bending of the optical sheet for display use over time. Incidentally, the width of the convex part 239 (in other words the width of the notch 238), its number and arrangement can be altered as desired.

### Example 3

### Third Embodiment

The top layer, the bottom layer and the intermediate layer were punched into a rectangular shape of the same planar size, nine holes 44 of 2 mm in diameter were formed at 20 mm intervals only in the prism sheet 14′, and the top layer and bottom layer diffusion sheets 16′ and 12′ were joined via the holes 244 by using an ultrasonic welding machine of a spot type measuring 1.3 mm in diameter.

As a result, satisfactory joining was successfully accomplished with no problem in external dimensions, appearance (absence of bending), adhesive strength and optical performance of the optical sheet for display use, which is the laminated sheet composition 30. Nor was observed any bending of the optical sheet for display use over time.

### Example 4

### Sixth Embodiment

The top layer, the bottom layer and the intermediate layer were punched into a rectangular shape of the same planar size, holes 246B each of 2.5 mm in diameter were formed in the four corners of the prism sheet 14′, and holes 246A and 246C of 1.5 mm in diameter were formed in the diffusion sheets 12′ and 16′ to form through holes 246. The through hole 246 part was welded with the impulse sealer 225 whose heating section was acicularly shaped.

As a result, satisfactory joining was successfully accomplished with no problem in external dimensions, appearance (absence of bending), adhesive strength and optical performance of the optical sheet for display use, which is the laminated sheet composition 30. Nor was observed any bending of the optical sheet for display use over time.

### (4) Examples in the Fourth Embodiment of the Invention

As the prism sheets 14 and 16, the first diffusion sheet 12 and the second diffusion sheet 18 were prepared in the same way as in their respective counterparts in the example in the first embodiment of the invention, the description is omitted.

The following examples were performed by using these sheets.

### Example 1

The sheet configuration of the optical sheet for display use conformed to the first example shown in FIG. 1.

Thus, as shown in FIG. 34 and FIG. 35, the belt-shaped first diffusion sheet 12, first prism sheet 14, second prism sheet 16 and second diffusion sheet 18 fed out of the rollers 412B, 414B, 416B and 418B were stacked on the upstream side of the punching press 448, and the belt-shaped uncut laminated sheet composition 10′ which resulted from the stacking was punched with the punching press 448 equipped with the punching blade for external shaping and the punching blade for joining use 420.

The punching blade for joining use 420 used was what gave a U-shaped punched shape 425, and its edge angle, the U-width of the U shape and the U-height were respectively 45°, 1.5 mm and 2.0 mm, respectively, with the paired sides of the U shape being 3 mm apart from each other. As shown in FIG. 46, four punched shapes 425, each comprising opposite paired ones, were formed at a right angle in each of the four corners of the edges of the laminated sheet composition 10, namely totaling 16 holes on the whole plane.

As a result, satisfactory joining was successfully accomplished with no problem in external dimensions, appearance (absence of bending), adhesive strength and optical performance of the optical sheet for display use, which is the laminated sheet composition 10. Nor was observed any bending of the optical sheet for display use over time.

### Example 2

Example 2 was joined, as shown in FIG. 45, by punching six pairs of punched shapes 425, each pair comprising mutually opposite holes, or a total of 12, in one side of the edge of the laminated sheet composition 10 with the punching blade for joining use 420. Other conditions were the same as in the example 1.

As a result, satisfactory joining was successfully accomplished with no problem in external dimensions, appearance (absence of bending), adhesive strength and optical performance of the optical sheet for display use, which is the laminated sheet composition 10. Nor was observed any bending of the optical sheet for display use over time.

1. An optical sheet for display use, wherein
two or more optical sheets are stacked therein and the optical sheets are joined to one another on one peripheral side of each by a thermoadhesive film.

2. An optical sheet for display use, wherein
two or more optical sheets are stacked therein and the optical sheets are joined to one another on two or more peripheral sides of each by a thermoadhesive film.

3. The optical sheet for display use according to claim 1, wherein
the thermoadhesive film is positioned between the optical sheets on the peripheral side or sides.

4. The optical sheet for display use according to claim 3, wherein
the thermoadhesive film is arranged in a position of no more than 2 to 4 mm from the edges of the optical sheets.

5. The optical sheet for display use according to claim 1, wherein
the thermoadhesive film is adhered to the end faces of the optical sheets on the peripheral side or sides.

6. The optical sheet for display use according to claim 1, wherein
the thickness of the thermoadhesive film after the adhesion is not more than 0.1 mm.

7. The optical sheet for display use according to claim 1, wherein
the thermoadhesive film is a polyester film.

8. The optical sheet for display use according to claim 1, wherein
the optical sheets include a diffusion sheet.

9. The optical sheet for display use according to claim 1, wherein
the optical sheets include a lens sheet over which convex lenses formed in a monoaxial direction are arranged substantially all over the face adjoining one another.

10. The optical sheet for display use according to claim 1, wherein
the optical sheets include two or more sheets of the same optical performance.

11. The optical sheet for display use according to claim 1, wherein
a laminate of the optical sheets is used for the back light unit of a display device.

12. An optical sheet for display use, wherein
two or more optical sheets are stacked and a through hole or holes are formed in one or more parts of the edge of the stacked laminate and the optical sheets are engaged with each other by the through hole or holes.

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. An apparatus for manufacturing an optical sheet for display use provided with:
a table which holds two or more stacked optical sheets;
an elevating stage which brings up and down a plurality of acicular members; and
a heating device which heats the acicular members, wherein:
the heated acicular members can form through holes in a plurality of positions on the edge of the laminate of the optical sheets.

27. An apparatus for manufacturing an optical sheet for display use provided with:
a table which holds two or more stacked optical sheets;
an elevating stage which brings up and down a plurality of acicular members;
a holding member in each of which an insertion hole allowing the acicular member to be inserted is formed and which press the edge of the laminate of the optical sheets; and
a heating device which heats the acicular members, wherein
the holding members press the edge of the laminate of the optical sheets, and
the heated acicular members can form through holes in a plurality of positions on the edge of the laminate of the optical sheets.

28. A method of manufacturing an optical sheet for display use including a joining step at which a laminated sheet composition formed by stacking three or more optical sheets is joined in at least one or more position of the edge thereof to integrate the composition, wherein only the optical sheet constituting the top layer and the optical sheet constituting the bottom layer of the laminated sheet composition are joined at the joining step.

29. (canceled)

30. (canceled)

31. (canceled)

32. (canceled)

33. (canceled)

34. (canceled)

35. (canceled)

36. An optical sheet for display use integrated by being joined in at least one position of the edge of a laminated sheet composition formed by stacking three or more optical sheets, wherein only the optical sheet of the top layer and the optical sheet of the bottom layer of the laminated sheet composition are joined.

37. (canceled)

38. (canceled)

39. (canceled)

40. (canceled)

41. A method of manufacturing an optical sheet for display use including a joining step at which a laminated sheet composition formed by stacking a plurality of optical sheets is joined in one or more positions of the edge thereof to integrate the composition, wherein
the laminated sheet composition is joined at the joining step by punching the peripheral part of the laminated sheet composition in a desired punched shape leaving a linking part.

42. (canceled)

43. (canceled)

44. (canceled)

45. (canceled)

46. (canceled)

47. (canceled)

48. (canceled)

49. An apparatus for manufacturing an optical sheet for display use provided with a joining device which integrates a laminated sheet composition, formed by stacking a plurality of optical sheets, by joining the composition in one or more positions on the peripheral part thereof, wherein
the joining device is a punching press device provided with a punching blade for joining use, in which a notch for punching the composition leaving a linking part intact is cut.

50. (canceled)

51. (canceled)

52. (canceled)

53. (canceled)

54. (canceled)

55. An optical sheet for display use integrated by joining the composition in one or more positions on the peripheral part of the laminated sheet composition formed by stacking a plurality of optical sheets, wherein
the laminated sheet composition is joined by the engagement of the optical sheets with each other, as the peripheral part of the laminated sheet composition is punched in a desired punched shape leaving a linking part intact, in that punched section.
